(19) United States
(12) Patent Application Publication
(10) Pub. No.: US 2015/0291116 A1
(43) Pub. Date: Oct. 15, 2015

(54) DEPLOYABLE SIDE PROTECTOR FOR VEHICLES

(71) Applicant: Konrad David Pi, Superior, CO (US)

(72) Inventor: Konrad David Pi, Superior, CO (US)

(21) Appl. No.: 14/682,538

(22) Filed: Apr. 9, 2015

Related U.S. Application Data
(60) Provisional application No. 61/978,987, filed on Apr. 14, 2014.

(51) Int. Cl. B60R 19/42; B60R 19/24; B60R 19/02; B60R 3/00

(52) U.S. Cl. CPC B60R 19/42; B60R 3/002; B60R 19/24; B60R 19/023

(57) ABSTRACT

A deployable side protector device (hereinafter, “side protector”) for protecting a subject vehicle from side impacts is disclosed and described. In various exemplary embodiments, the subject vehicle may have two side protectors mounted to the subject vehicle, one side protector for protecting the subject vehicle's left side and one side protector for protecting the subject vehicle's right side. Each respective side protector, right and left, may be controllable by a single controller. Additionally, each respective side protector, right and left, may be either in a deployed configuration, a retracted stored configuration, or in a state of transition between one of those two configurations. Further when deployed, a horizontal vehicle side protection bar may be located at an optimal height for protecting against side impacts.

### PRIORITY NOTICE

The present application claims priority under 35 U.S.C. §119(e) to U.S. Provisional Patent Application Ser. No. 61/978,987 filed on Apr. 14, 2014, the disclosure of which is incorporated herein by reference in its entirety.

### CROSS REFERENCE TO RELATED PATENT APPLICATIONS

The present application makes no reference to any other related filed patent applications except for explicit reference to U.S. Provisional Patent Application Ser. No. 61/978,987 filed on Apr. 14, 2014, the disclosure of which is incorporated by reference in its entirety as noted above.

### STATEMENT REGARDING FEDERAL SPONSORSHIP

No part of this invention was a result of any federally sponsored research.

### TECHNICAL FIELD OF THE INVENTION

The present invention relates in general to protecting a subject vehicle from side impacts and more specifically to deployable side protectors configured to protect the subject vehicle from side impacts, where such side impacts may arise from the opening of adjacent vehicle doors or from shopping carts striking the subject vehicle.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Currently the parking of vehicles in various parking spots generally exposes the parked vehicle to various risks of impact and damage resulting from such impacts. Vehicles in this context refers to consumer cars, SUVs, cross-overs, pickup trucks, vans, minivans, and the like. Various parking spots may be found in parking lots, parking structures, and street parking scenarios. In general such parking spots share close physical proximity to adjacent parking spots, putting parked vehicles in close proximity to each other. Such a geometric arrangement necessarily exposes parked vehicles to the risk of impacts arising from the opening of vehicle doors which then because of the close proximity said doors may strike and damage adjacent vehicles. Additionally, vehicles parked in consumer retail areas are also often exposed to impact risks from shopping carts striking the vehicles.

Thus it would be clearly desirable to provide a means for protecting parked vehicles from impacts arising from adjacent vehicle car doors and from shopping carts.

The art has largely responded to this need with side protectors permanently affixed to the sides of vehicles. However, such permanent side protectors are often unattractive and detract from the vehicles overall aesthetic appearance. [protrude, material difference, color] This problem associated with the use of permanent side protectors as a side impact solution arises because of three factors. First, the permanent side protectors must protrude some distance from the vehicle side exterior in order to protect the vehicle's side. Thus, to some extent it is always obvious when permanent side protectors are being used, since the protrusion can readily be seen. And such protrusion detracts from an otherwise coherent exterior design of a vehicle. Secondly, the permanent side protectors are of a different material of construction than the vehicle exterior side and this difference in materials is also readily apparent and detracts from the coherent exterior design of the vehicle. Lastly, and likely a result of the different materials employed, color matching the permanent side protectors never quite matches the exterior side color of the vehicle and again this allows the permanent side protectors to detract from the otherwise coherent exterior design of the vehicle.

To deal with the above problems of permanent side protectors the art has largely just focused on minimizing the protrusions and moving the color matching closer to the vehicle's overall color.

There is then a need in the art for an alternative to using permanent side protectors to protect vehicles from side impacts. As an alternative it would be desirable to utilize an automatically deployable side protector which may be deployed when a vehicle is parked and retracted and stored in a convenient location when the vehicle is in use.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a deployable side protector device (hereinafter, “side protector”) for protecting a subject vehicle from side impacts. In various exemplary embodiments, the subject vehicle may have two side protectors mounted to the subject vehicle, one side protector for protecting the subject vehicle's left side and one side protector for protecting the subject vehicle's right side. Each respective side protector, right and left, may be controllable by a single controller. Additionally, each respective side protector, right and left, may be either in a deployed configuration, a retracted stored configuration, or in a state of transition between one of those two configurations. Further when deployed, a horizontal vehicle side protection bar (HVSPB) may be located at an optimal height for protecting against side impacts.

It is an objective of the present invention to provide a side protector for protecting a subject vehicle from side impacts.

It is another objective of the present invention to provide a side protector which may be deployable when desired to have the side protector in place.

It is another objective of the present invention to provide a side protector which may be retractable from the deployed configuration.

It is another objective of the present invention to provide a side protector when retracted that the side protector may be stored in a convenient location.

It is another objective of the present invention to provide a side protector when retracted and stored in a convenient location that said storage may not interfere with the normal operation of the vehicle.

It is another objective of the present invention to provide a side protector whose alternating deployed and retracted configurations may be controlled by a remote control device and from the vehicle's console.

It is yet another objective of the present invention to provide a side protector which may deploy and/or retract quickly.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 may depict an exemplary embodiment of a deployable side protector (hereinafter, “side protector”) for vehicles for protecting a subject vehicle from side impacts—wherein in FIG. 1 the side protectors may be depicted in a retracted stored configuration—shown in a perspective view.

FIG. 1A may depict the exemplary embodiment of the side protector of FIG. 1—depicted where the side protector may be in a process of deployment, with an extension arm extended but not yet rotated—shown in a perspective view.

FIG. 1B may depict the exemplary embodiment of the side protector of FIG. 1—depicted fully deployed, with the extension arm extended and rotated such that a telescoping horizontal vehicle side protection bar (HVSPB) may be fully deployed—shown from a perspective view.

FIG. 1C may depict a close-up view of the front of FIG. 1B, depicting a front vertical support strut subassembly (VSSS) and HVSPB, shown from a perspective view.

FIG. 1D may depict the exemplary embodiment of the side protector of FIG. 1, in the fully deployed configuration, shown from a side view with the subject vehicle shown as well.

FIG. 1E may depict the exemplary embodiment of the side protector of FIG. 1 in the fully deployed configuration, shown from a top view with the subject vehicle shown as well.

FIG. 1F may depicts the exemplary embodiment of the side protector of FIG. 1 in the fully deployed configuration, shown from a front view with the subject vehicle shown as well.

FIG. 2A may depict an exemplary embodiment of a deployable side protector for protecting the subject vehicle from side impacts—wherein in FIG. 2A the side protector may be depicted in a retracted stored configuration—shown in a perspective view.

FIG. 2B may depict the exemplary embodiment of FIG. 2A, but where the side protector may be in a state of partial horizontal deployment—but not yet in a state of full operational deployment.

FIG. 2C may depict the exemplary embodiment of FIG. 2A, but where the side protector may be in a state of full horizontal deployment—but not yet in a state of full operational deployment.

FIG. 2D may depict the exemplary embodiment of FIG. 2A, but where the side protector may be in a state of partial rotational deployment (and full horizontal deployment)—but not yet in a state of full operational deployment.

FIG. 2E may depict the exemplary embodiment of FIG. 2A, but where the side protector may be in a state of full rotational deployment (and full horizontal deployment)—but not yet in a state of full operational deployment.

FIG. 2F may depict the exemplary embodiment of FIG. 2A, but where the side protector may be in a state of partial vertical deployment (and full rotational deployment and full horizontal deployment)—but not yet in a state of full operational deployment.

FIG. 2G may depict the exemplary embodiment of FIG. 2A, but where the side protector may be in a state of full vertical deployment (and full rotational deployment and full horizontal deployment)—FIG. 2G may depict a state of full operational deployment for the side protector.

FIG. 3 may depict the state of full operational deployment for the side protector of FIG. 2A, while the side protector may be operating to protect the subject vehicle from a side impact originating from an adjacent parked vehicle, shown from a perspective view.

FIG. 4A may depict an exemplary embodiment of a side protector incorporated into a vehicle's running board (a side-protector-housing in some embodiments), shown from a top perspective view with a side-protector-housing door closed.

FIG. 4B may depict the exemplary embodiment of FIG. 4A, but from a bottom perspective view also showing the side-protector-housing door closed and showing the side-protector-housing (housing) which may contain the side protector.

FIG. 4C may depict the exemplary embodiment of FIG. 4A, also from the top perspective view but showing the side-protector-housing door open.

FIG. 4D may depict the exemplary embodiment of FIG. 4A, from a side perspective view showing the side-protector-housing door open.

FIG. 4E may depict the exemplary embodiment of FIG. 4A, but from the bottom perspective view showing the side-protector-housing door open and showing the housing which may contain the side protector.

FIG. 4F may depict the exemplary embodiment of FIG. 4A, but from the bottom perspective view showing the side-protector-housing door open and showing a bottom portion of the housing removed so the side protector may be seen in the retracted and stored configuration.

FIG. 5A may depict an exemplary embodiment of a securing pin subassembly, with the securing pin in a retracted configuration, shown from a perspective transparent view.

FIG. 5B may depict the exemplary embodiment of FIG. 5A, shown from a cross-sectional perspective view.

FIG. 5C may depict the exemplary embodiment of FIG. 5A, but with the securing pin in a deployed (i.e. locked or secured) configuration, shown from the cross-sectional perspective view.

FIG. 6A may depict an exemplary embodiment of side protectors from a top view in relation to a controller and a power source.

FIG. 6B may depict the exemplary embodiment of FIG. 6A from a front view.

FIG. 6C may depict an exemplary embodiment of the controller for controlling the deployment and retraction of a side protector, shown as a schematic block diagram.

### REFERENCE NUMERAL LISTING (SCHEDULE)

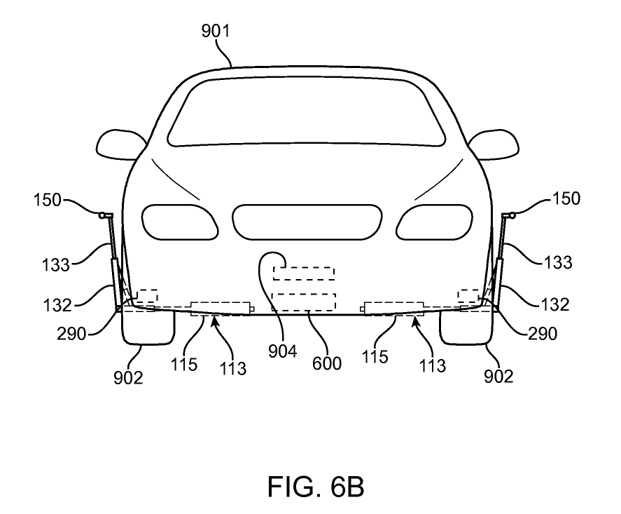

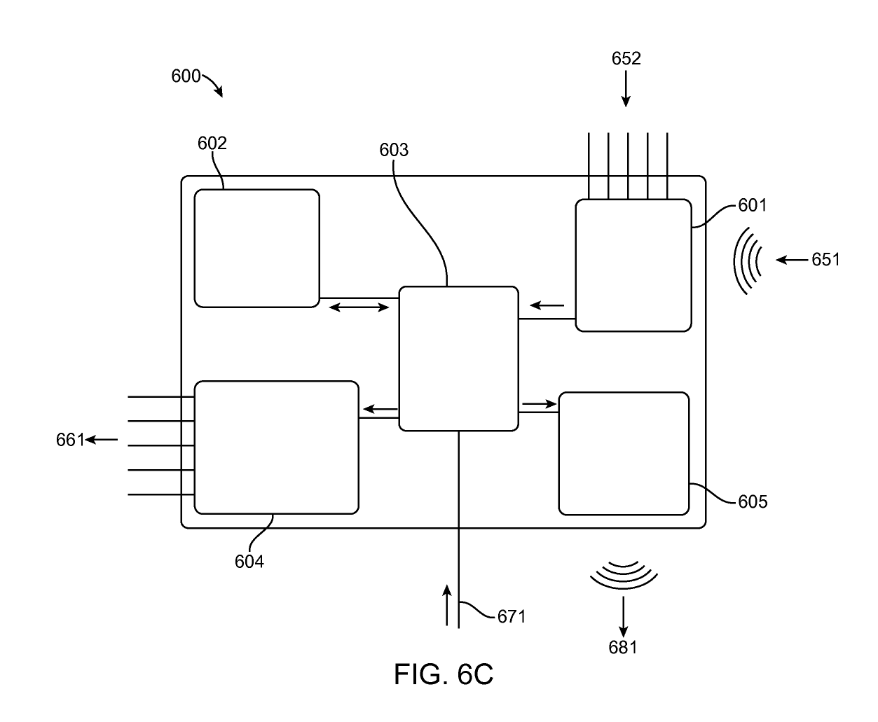

100 side protector 100
110 front mounted-extension-rotation-subassembly 110 (front MERS 110)
111 front extension arm 111
112 front VSSS terminal end 112
113 front extension means 113
114 front rotating means 114
115 front extension arm housing 115
116 front mounting structure 116
120 rear mounted-extension-rotation-subassembly 120 (rear MERS 120)
121 rear extension arm 121
122 rear VSSS terminal end 122
123 rear extension means 123
124 rear rotating means 124
125 rear extension arm housing 125
126 rear mounting structure 126
130 front vertical support struts 130 (front VSSS 130)
131 front lower mounting support 131
132 front vertical support strut housing 132
133 front vertical support strut 133
134 front connection terminal end 134
135 front pivot joint 135
136 front impact absorber 136
140 rear vertical support struts 140 (rear VSSS 140)
141 rear lower mounting support 141
142 rear vertical support strut housing 142
143 rear vertical support strut 143
144 rear connection terminal end 144
145 rear pivot joint 145
146 rear impact absorber 146
150 horizontal vehicle side protection bar subassembly 150 (HVSPB 150)
151 front bar section 151
152 front connection end 152
153 rear bar section 153
154 rear bar terminal end 154
155 proximal distance 155
200 side protector 200 at least one mounted-extension-rotation-subassembly (MERS)
211 extension arm 211
212 at least one extension arm bracket 212 (sleeve 212)
213 L-bracket 213
214 disposed terminal end 214 extension actuator
216 screw arm 216
217 slide 217
218 extension-motor 218
219 extension actuator housing 219
221 slot 221
225 rotator 225
226 central spinning axis 226
228 mounting structure 228
235 at least one vertical-support-strut-subassembly 235 (VSSS 235)
236 bottom terminal end 236
237 top terminal end 237
238 impact absorber 238
239 lower end 239
240 upper end 240
242 strut housing 242 vertical extender
243 vertical-screw-arm 243
244 vertical-motor 244
242 strut housing 242
245 base 245
246 strut 246
247 strut housing opening 247
250 at least one HVSPBS 250
251 rear-terminal-end 251
252 front-terminal-end 252
253 rear bar 253
254 front bar 254
255 slide 255 (reinforcement core 255)
256 bar-slot 256
257 third elongate member 257
258 location 258 (on HVSPBS 250)
259 point 259 (on HVSPBS 250)
290 retraction locking magnet 290 (see e.g., FIG. 6A and FIG. 6B)
400 running board with integral side protector 400
461 top platform 461
465 side-protector-housing 465 (housing 465)
466 side-protector-housing opening 466
467 side-protector-housing door 467 (door 467)
468 hinge 468
560 securing pin subassembly 560
561 pin-cavity 561
562 bottom 562
563 different flange 563
564 pin 564
565 flange 565
566 top portion 566
567 spring 567
568 electro-magnet 568
569 complimentary-concentric-pin-hole 569
600 controller 600
601 receiver 601
602 memory 602
603 processor 603
604 output means 604
605 transmitter 605
651 input 651
652 input 652
661 at least one output signal 661
671 incoming power 671
681 outgoing message 681
880 height off of ground 880 (height 880)
901 subject vehicle 901
902 front wheel 902
903 rear wheel 903
904 power source 904
905 undercarriage 905
950 adjacent vehicle 950

### DETAILED DESCRIPTION OF THE INVENTION

A deployable side protector device (hereinafter, “side protector”) for protecting a subject vehicle from side impacts is disclosed and described. In various exemplary embodiments, the subject vehicle may have two side protectors mounted to the subject vehicle, one side protector for protecting the subject vehicle's left side and one side protector for protecting the subject vehicle's right side. Each respective side protector, right and left, may be controllable by a single controller. Additionally, each respective side protector, right and left, may be either in a deployed configuration, a retracted stored configuration, or in a state of transition between one of those two configurations.

Note unless otherwise stated, references to “front” and “rear” are always with respect to a same given side of the subject vehicle, which could be either the right side or the left side. For example, reference to the front wheel and the rear wheel would then be in reference to the wheels on the same given side of the subject vehicle, which could be either the right or the left side. In other words, reference to the “front wheel and to the rear wheel” would not mean a reference to a front right wheel and a left rear wheel.

When deployed, a respective side protector, right or left, may be positioned such that a horizontal vehicle side protection bar (HVSPB) may run horizontally from near the subject vehicle's front wheel on a given side (right or left) to a region in proximity to the subject vehicle's rear wheel on that same side, which generally then protects the subject vehicle's side doors from impact. For example, and without limiting the scope of the present invention, “near the subject vehicle's front wheel” may be a portion of the HVSPB being within sixteen inches of said front wheel. And “a region proximity to the subject vehicle's rear wheel” may be a different portion of the HVSPB being from two to sixteen inches to said rear wheel.

Additionally in various exemplary embodiments, when deployed, the HVSPB may be at a height, an optimal height, with respect to a ground upon which the subject vehicle is resting upon. In various exemplary embodiments this height may be adjusted to a desired height for a given make and model of subject vehicle. Or in alternative exemplary embodiments, this height may be fixed for a given make and model of subject vehicle that the exemplary side protector was manufactured for. For example, many sports cars have chassis which are generally lower to the ground than a comparable non-sports car and also generally have a vehicle height which is less than a comparable non-sports car. Thus, if such a sports car were parallel parked next to a pick-up truck, the pick-up truck's door could strike the side of the sports car well above a half-way point of the sports car's height. Additionally, the converse may true as well, i.e. if the sports car's door could strike the side of the pick-up truck well below the half-way point of the pick-up trucks height.

So if the sports car was affixed with a permanent side protector of the prior art type described above (e.g. affixed midway on the subject vehicle's side doors), such a permanent side protector may be ineffective in protecting the sports car from side impacts of vehicles like pickup trucks whose doors may strike the sports car at a higher location on the side of the sports car. Whereas, in the various exemplary embodiments of the present invention, the height could be adjusted to raise the HVSPB to a desired height and protect the sports car from side impacts from the pickup truck door.

With respect to the retracted stored configuration, in such a configuration the side protector may be stored in a convenient location, where the convenient location may be the undercarriage of the subject vehicle. Thus, when the side protector is not use it may be stored in a location which is not only convenient, but also does not interfere with normal operation of the subject vehicle. Further, when said side protector may be in the retracted and stored configuration, said side protector may not be visible by a user standing next to the subject vehicle and thus the side protector may not impact negatively upon the subject vehicle's appearance.

Now this discussion turns to the exemplary embodiments depicted in the attached and incorporated figures. In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

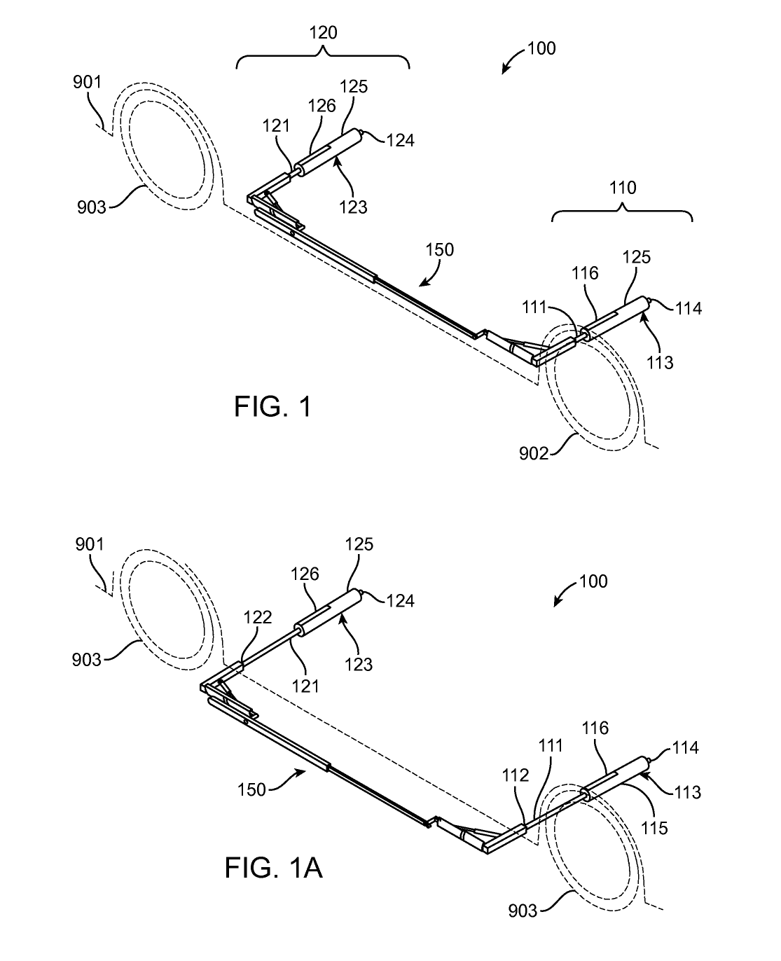

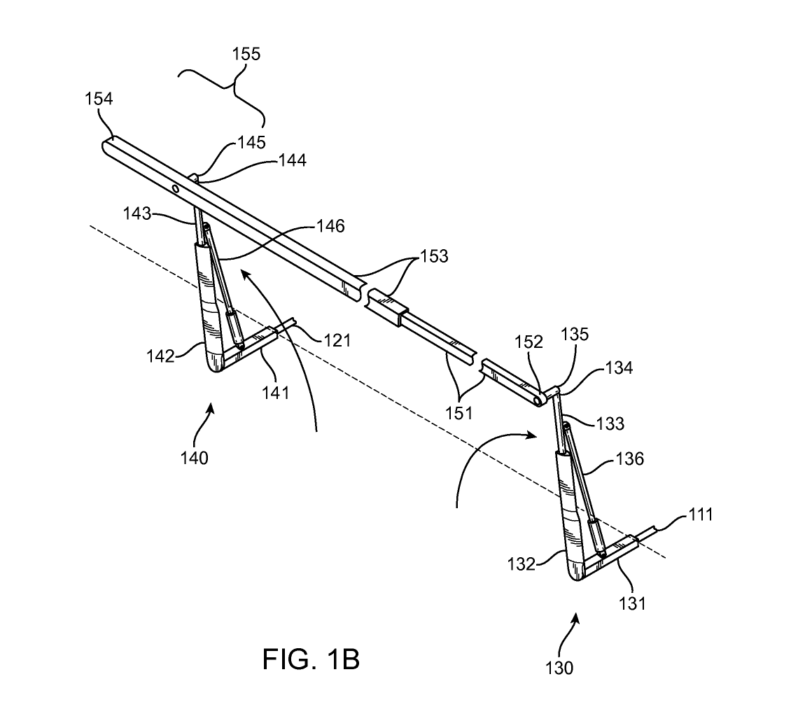

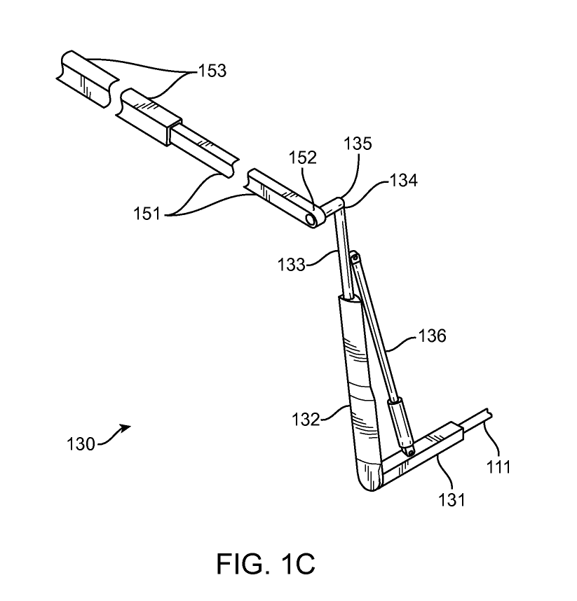

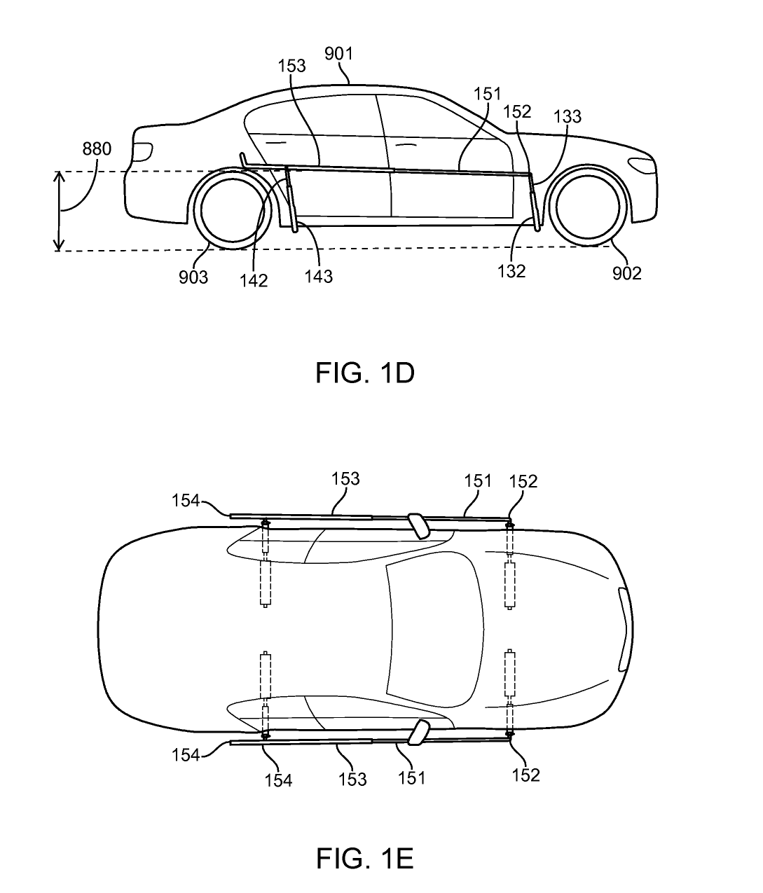

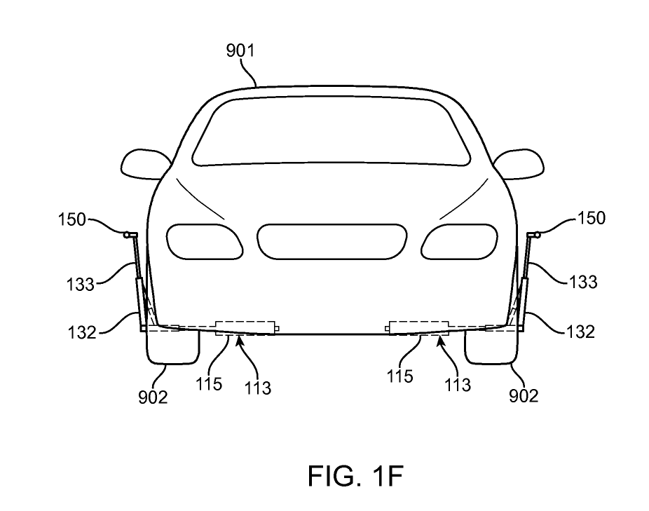

FIG. 1 depicts an exemplary embodiment of side protector 100 for protecting subject vehicle 901 from side impacts—where side protector 100 may be in a retracted stored configuration—shown in a perspective view.

Side protector 100 may comprise: (1) at least two mountable-extension-rotation subassemblies (MERS); (2) at least two vertical support strut subassemblies (VSSS); (3) at least one horizontal vehicle side protection bar subassembly (HVSPB) 150; and (4) controller 600. Each of these subcomponents is discussed below, first in terms of overall function of each subcomponent and then in structural detail as to the various elements which may comprise a given subcomponent.

The at least two MERS may comprise front MERS 110 located on subject vehicle 901's undercarriage in proximity to front wheel 902 and behind said front wheel 902; and rear MERS 120 located in subject vehicle 901's undercarriage in proximity to rear wheel 903, in front of said rear wheel 903 and on a same side of subject vehicle 901 as the location of front MERS 110.

Each respective MERS may serve three functions: (1) providing the point of attachment of side protector 100 to subject vehicle 901; (2) providing a means for deployment and retraction of side protector 100; and (3) may provide feedback to controller 600 of a status of side protector 100.

The at least two vertical support strut subassemblies (VSSS) may comprise front VSSS 130 and rear VSSS 140. Functionally each respective VSSS, front VSSS 130 and rear VSSS 140, may be in communication with each respective MERS, front MERS 110 and rear MERS 120; and the pair of VSSS, front VSSS 130 and rear VSSS 140, may also be in simultaneous communication with HVSPB 150. Further, each respective VSSS, front VSSS 130 and rear VSSS 140, may serve three functions: (1) to communicate the rotational movement provided by each respective MERS to HVSPB 150 which may aid in the deployment of HVSPB 150; (2) to provide structural support to HVSPB 150 such that when HVSPB 150 receives an impact each respective VSSS operates to absorb and mitigate the impact; and (3) to raise HVSPB 150 to height 880 when HVSPB 150 is deployed.

Note, height 880 may not be readily depicted in FIG. 1, to see a better depiction of height 880 see FIG. 1D.

The at least one HVSPB 150 may be the subcomponent of side protector 100 that receives impacts. HVSPB 150 may be in communication with front VSSS 130 and rear VSSS 140. Once side protector 100 may be deployed said HVSPB 150 may be in a horizontal position running from near front wheel 902 to a region in proximity to rear wheel 903 and at a height off of the ground 880 that permits said HVSPB 150 to receive probable side impacts and wherein front VSSS 130 and rear VSSS 140 may function to absorb and mitigate side impacts received to HVSPB 150. HVSPB 150, when deployed and when retracted and stored, may be generally parallel with the ground that subject vehicle 901 may be resting upon.

Controller 600 may control deployment and retraction of side protector 100. With respect to deployment of a given HVSPB 150, upon controller 600 receiving a deploy command, controller 600 may cause deployment by first causing a dual extension maneuver (directed at front MERS 110 and rear MERS 120) which may then be followed by a dual but opposing rotational maneuver (also directed at front MERS 110 and rear MERS 120).

In further detail, controller 600 may cause deployment by causing: (1) front MERS 110 to extend front extension arm 111, rear MERS 120 to simultaneously extend rear extension arm 121; and (2) front MERS 110 to rotate front extension arm 111 towards the front wheel 902, and rear MERS 120 to rotate the rear extension arm 121 toward the rear wheel 903. The opposing rotations may cause front VSSS 130 and rear VSSS 140 to transition from a horizontal position to a vertical position which may also then cause HVSPB 150 to telescope into the deployed configuration.

Retraction may be the reverse process, i.e. controller 600 may cause retraction and storage by first causing a dual but opposing rotational maneuver which may then be followed by a dual retraction maneuver.

Now turning to further structural details of each subcomponent of: (1) the at least two MERS (110 and 120); (2) the at least two VSSS (130 and 140); (3) the at least one HVSPB 150; and (4) controller 600.

As depicted in FIG. 1 and FIG. 1A front MERS 110 may comprise: front extension arm 111, front extension means 113, front rotating means 114, front extension arm housing 115, and front mounting structure 116. FIG. 1 may depict the two MERS in the retracted stored configuration, while FIG. 1A may depict the two MERS in the deployed configuration.

Front extension arm 111 may partially housed within front extension arm housing 115 in the retracted and stored configuration as depicted in FIG. 1. And front extension arm 111 may even less partially housed within front extension arm housing 115 in the deployed configuration as depicted in FIG. 1A. Additionally, front extension arm 111 may further comprise two terminal ends, with one of these terminal ends being designated front VSSS terminal end 112, which may be the terminal end of front extension 111 that may be attached to front lower mounting support 131 of front VSSS 130. Further, front extension arm housing 115 may comprise front mounting structure 116, i.e. front mounting structure 116 may be permanently attached to front extension arm 111. Front mounting structure 116 may provide structure to mount front extension arm housing 115 to subject vehicle 901. For example, and without limiting the scope of the present invention, front mounting structure 116 may comprise a plate with holes for screwing and/or bolting front mounting structure 116 to subject vehicle 901, generally upon a location of subject vehicle's undercarriage.

In terms of motion, deployment and its counterpart of retraction may require two motions, extension/retraction and rotation. Front extension means 113 may provide the means for extending front extension arm 111 from a retracted stored configuration to the deployed configuration and for retracting front extension arm 111 from the deployed configuration to the retracted stored configuration. In various exemplary embodiments, front extension arm housing 115 may also function as front extension means 113 by being configured to operate as a ram (i.e. piston). Such a ram (piston) may be powered by a motor, solenoid, pneumatically, or hydraulically.

Additionally, front rotating means 114 may provide for rotating front extension arm 111 towards the front wheel 902 to deploy and for rotating front extension arm 111 towards the rear wheel 903 to retract. That is, front extension arm 111 may be rotated along its longitudinal axis by front rotating means 114. Front rotating means 114 may be configured to operate as a motor, to rotate front extension arm 111 along its longitudinal axis. Front extension arm housing 115 may partially house such a motor's shaft where the shaft and the remaining terminal end of front extension arm 111 connect.

Rear MERS 120 may share equivalent structure and componentry as compared to front MERS 110. Rear MERS 120 may comprise: rear extension arm 121, rear extension means 123, rear rotating means 124, rear extension arm housing 125, and rear mounting structure 126.

Rear extension arm 121 may partially housed within rear extension arm housing 125 in the retracted and stored configuration as depicted in FIG. 1. And rear extension arm 121 may even less partially housed within rear extension arm housing 125 in the deployed configuration as depicted in FIG. 1A. Additionally, rear extension arm 121 may further comprise two terminal ends, with one of these terminal ends being designated rear VSSS terminal end 122, which may be the terminal end of rear extension 121 that may be attached to rear lower mounting support 141 of rear VSSS 140 (see e.g., FIG. 1B). Further, rear extension arm housing 125 may comprise rear mounting structure 126, i.e. rear mounting structure 126 may be permanently attached to rear extension arm 121. Rear mounting structure 126 may provide structure to mount rear extension arm housing 125 to subject vehicle 901. For example, and without limiting the scope of the present invention, rear mounting structure 126 may comprise a plate with holes for screwing and/or bolting rear mounting structure 126 to subject vehicle 901, generally upon a location of subject vehicle's undercarriage.

As noted above, in terms of motion, deployment and its counterpart of retraction may require two motions, extension/retraction and rotation. Rear extension means 123 may provide the means for extending rear extension arm 121 from a retracted stored configuration to the deployed configuration and for retracting rear extension arm 121 from the deployed configuration to the retracted stored configuration. In various exemplary embodiments, rear extension arm housing 125 may also function as rear extension means 123 by being configured to operate as a ram (i.e. piston), screw, chain driven rail system, and the like. Such ram, screw, chain, and/or driven rail systems may be powered by a motor, solenoid, pneumatically, or hydraulically.

Additionally, rear rotating means 124 may provide for rotating rear extension arm 121 towards the rear wheel 903 to deploy and for rotating rear extension arm 121 towards the front wheel 902 to retract. That is, rear extension arm 121 may be rotated along its longitudinal axis by rear rotating means 124. Rear rotating means 124 may be configured to operate as a motor, to rotate rear extension arm 121 along its longitudinal axis. Rear extension arm housing 125 may partially house such a motor's shaft where the shaft and the remaining terminal end of rear extension arm 121 connect.

In some exemplary embodiments, front extension means 113 and front rotating means 114 may be provided by a single front device; and rear extension means 123 and rear rotating means 124 may be provided by a single rear device.

Now turning to the at least two VSSS, front VSSS 130 and rear VSSS 140, as depicted in FIG. 1B and FIG. 1C. FIG. 1B may depict both front VSSS 130 and rear VSSS 140 with HVSPB 150 running between them, in the deployed configuration. Whereas, FIG. 1C may depict a close-up view of VSSS 130 and a portion of HVSPB 150 that may be connected to VSSS 130.

Front VSSS 130 may comprise: front lower mounting support 131, front vertical support strut housing 132, front vertical support strut 133, front pivot joint 135, and front impact absorber 136.

VSSS 130 may in communication with MERS 110 via front VSSS terminal end 112 of front extension arm 111 being attached to front lower mounting support 131. The nature of said attachment may such that any motion (e.g. extension, rotation, retraction) imparted to front extension arm 111 by front extension means 113 and front rotation means 114, may be communicated directly to front lower mounting support 131, i.e. the nature of said attachment may be permanent attachment not permitting any flexing at the attachment. Front lower mounting support 131 may comprise two terminal ends which longitudinally oppose each other, where one terminal may be attached to front VSSS terminal end 112; and the other terminal end may then be attached to front vertical support strut housing 132.

Front vertical support strut housing 132 may also comprise two terminal ends which longitudinally oppose each other, where one terminal may be attached to front lower mounting support 131. The remaining terminal end of front vertical support strut housing 132 may be configured to partially accept into a cavity of front vertical support strut housing 132, front vertical support strut 133. Note both “front vertical support strut housing 132” and “front vertical support strut 133” contain “vertical” in their names, because when side protector 100 may be deployed, both front vertical support strut housing 132 and front vertical support strut 133 may be vertical with respect to a ground surface upon which subject vehicle 901 rests. Additionally, “front vertical support strut housing 132” contains “strut housing” because front vertical support strut housing 132 may be configured to partially accept front vertical support strut 133 in the cavity of front vertical support strut housing 132.

Front vertical support strut 133 may also comprise two terminal ends which longitudinally oppose each other, where one terminal end 134 may be attached to front pivot joint 135. The remaining terminal end of front vertical support strut 133 may be housed within the cavity of front vertical support strut housing 132. Thus, front vertical support strut 133 may slide partially in and partially out of within the cavity of front vertical support strut housing 132.

And pivot joint 135 may serve to connect front VSSS 130 to HVSPB 150, such that regardless of configuration HVSPB 150 tends to be maintained in a horizontal position with respect to the ground surface upon which subject vehicle 901 rests.

Lastly, front VSSS 130 may comprise front impact absorber 136. Front impact absorber 136 may be configured to operate as a ram (i.e. piston), with a ram arm and a ram arm housing, where both the ram arm and the ram arm housing may comprise two terminal ends longitudinally opposing each other. Such a linear structure of front impact absorber 136 may be attached to front lower mounting support 131 at one end and to front vertical support strut 133 at the other end (or to front vertical support strut housing 132 at the other end—this embodiment not depicted in FIG. 1B). The end of front impact absorber 136 that may attach to front vertical support strut 133 may be at a location on front vertical support strut 133 which is not housed within front vertical support strut housing 132.

Front impact absorber 136 may function in the deployed configuration to provide the lifting force to place HVSPB 150 at height 880. Additionally, front impact absorber 136 may function to absorb impacts to HVSPB 150 by acting as a shock absorber.

Rear VSSS 140 may share equivalent structure and componentry compared to front VSSS 130. Rear VSSS 140 may comprise: rear lower mounting support 141, rear vertical support strut housing 142, rear vertical support strut 143, rear pivot joint 145, and rear impact absorber 146.

Rear VSSS 140 may in communication with rear MERS 120 via rear VSSS terminal end 122 of rear extension arm 121 being attached to rear lower mounting support 141. The nature of said attachment may such that any motion (e.g. extension, rotation, retraction) imparted to rear extension arm 121 by rear extension means 123 and rear rotation means 124, may be communicated directly to rear lower mounting support 141, i.e. the nature of said attachment may be permanent attachment not permitting any flexing at the attachment. Rear lower mounting support 141 may comprise two terminal ends which longitudinally oppose each other, where one terminal may be attached to rear VSSS terminal end 122; and the other terminal end may then be attached to rear vertical support strut housing 142.

Rear vertical support strut housing 142 may also comprise two terminal ends which longitudinally oppose each other, where one terminal may be attached to rear lower mounting support 141. The remaining terminal end of rear vertical support strut housing 142 may be configured to partially accept into a cavity of rear vertical support strut housing 142, rear vertical support strut 143. Note both “rear vertical support strut housing 142” and “rear vertical support strut 143” contain “vertical” in their names, because when side protector 100 may be deployed, both rear vertical support strut housing 142 and rear vertical support strut 143 may be vertical with respect to a ground surface upon which subject vehicle 901 rests. Additionally, “rear vertical support strut housing 142” contains “strut housing” because rear vertical support strut housing 142 may be configured to partially accept rear vertical support strut 143 in the cavity of rear vertical support strut housing 142.

Rear vertical support strut 143 may also comprise two terminal ends which longitudinally oppose each other, where one terminal end 144 may be attached to rear pivot joint 145. The remaining terminal end of rear vertical support strut 143 may be housed within the cavity of rear vertical support strut housing 142. Thus, rear vertical support strut 143 may slide partially in and partially out of within the cavity of rear vertical support strut housing 142.

And pivot joint 145 may serve to connect rear VSSS 140 to HVSPB 150, such that regardless of configuration HVSPB 150 tends to be maintained in a horizontal position with respect to the ground surface upon which subject vehicle 901 rests.

Lastly, rear VSSS 140 may comprise rear impact absorber 146. Rear impact absorber 146 may be configured to operate as a ram (i.e. piston), with a ram arm and a ram arm housing, where both the ram arm and the ram arm housing may comprise two terminal ends longitudinally opposing each other. Such a linear structure of rear impact absorber 146 may be attached to rear lower mounting support 141 at one end and rear vertical support strut 143 at the other end (or to rear vertical support strut housing 142 at the other end—this embodiment not depicted in FIG. 1B). The end of rear impact absorber 146 that may attach to rear vertical support strut 143 may be at a location on rear vertical support strut 143 which is not housed within rear vertical support strut housing 142.

Rear impact absorber 146 may function in the deployed configuration to provide the lifting force to place HVSPB 150 at height 880. Additionally, rear impact absorber 146 may function to absorb impacts to HVSPB 150 by acting as a shock absorber.

Thus, when front MERS 110 may cause front extension arm 111 to rotate towards the front wheel 902 by front rotation means 114 and where rear MERS 120 may cause rear extension arm 121 to rotate towards rear wheel 903 by means of rear rotation means 124, front VSSS 130 may transition into the vertical position where front impact absorber 136 may then acts to raise one end of HVSPB 150 to height 880 and rear VSSS 140 may transition into the vertical position where rear impact absorber 146 may then acts to raise the other end of HVSPB 150 to height 880.

Now turning to HVSPB 150 as depicted in FIG. 1B, FIG. 1C, FIG. 1D, FIG. 1E, and FIG. 1F. FIG. 1D may depict a side view of one HVSPB 150 in relation to subject vehicle 901 that side protector 100 may be installed upon. FIG. 1E may depict a top view two HVSPB 150's in relation to subject vehicle 901 that side protector 100 may be installed upon. And FIG. 1F may depict a front view two HVSPB 150's in relation to subject vehicle 901 that side protector 100 may be installed upon.

HVSPB 150 may comprise front bar section 151 and rear bar section 153. Each bar section, 151 and 153, may each be comprise of two terminal ends which longitudinally opposing each other. Front bar section 151 may further comprise front connection end 152 as one of its terminal ends. Front connection end 152 may be coupled to (attached to) front pivot joint 135 of front VSSS 130. The other remaining terminal end of front bar section 151 may be housed within a cavity of rear bar section 153. Thus, portions of front bar section 151 may slide partially in and partially out of the cavity of rear bar section 153. Hence, one terminal end of front bar section 151 may be in communication with one terminal end of rear bar section 153. Rear bar section 153 may also comprise rear bar terminal end 154. In some embodiments, rear bar terminal end 154 may be coupled to rear pivot joint 145 of rear VSSS 140 (this embodiment is not depicted). Note, the location of rear bar terminal end 154 on rear bar section 153 may be at the remaining terminal end of rear bar section 153, see e.g., FIG. 1B and FIG. 1E. As depicted in the figures (e.g., FIG. 1B), rear bar terminal end 154 may be some proximal distance 155 from rear pivot joint 145 by proximal distance 155. In various exemplary embodiments, this proximal distance 155 may be from about one quarter inch to about twenty-nine inches.

During deployment, a portion of front bar section 151 may telescopically extend from the cavity of rear bar section 153 to form deployed HVSPB 150.

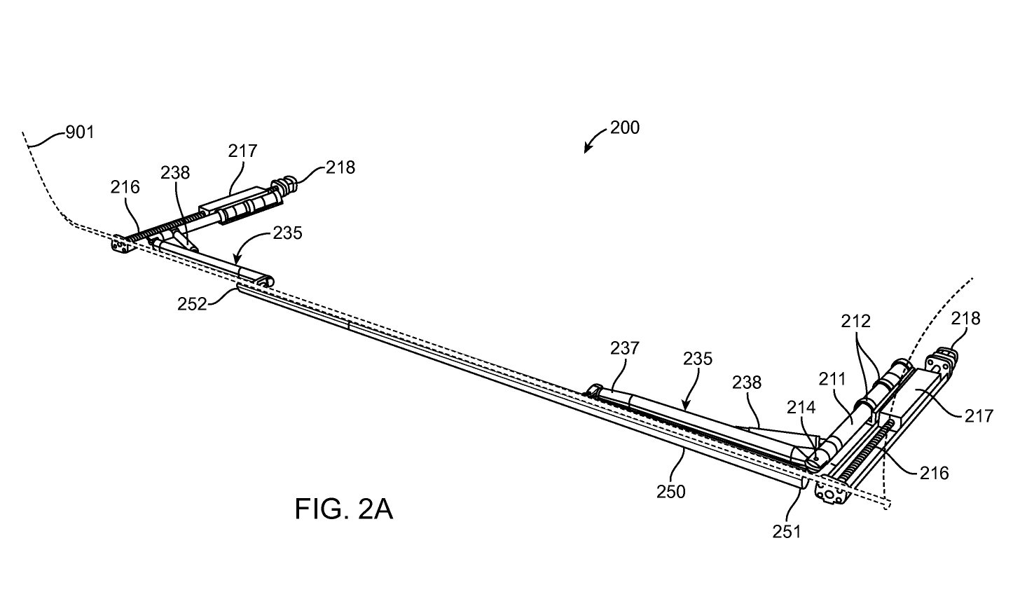

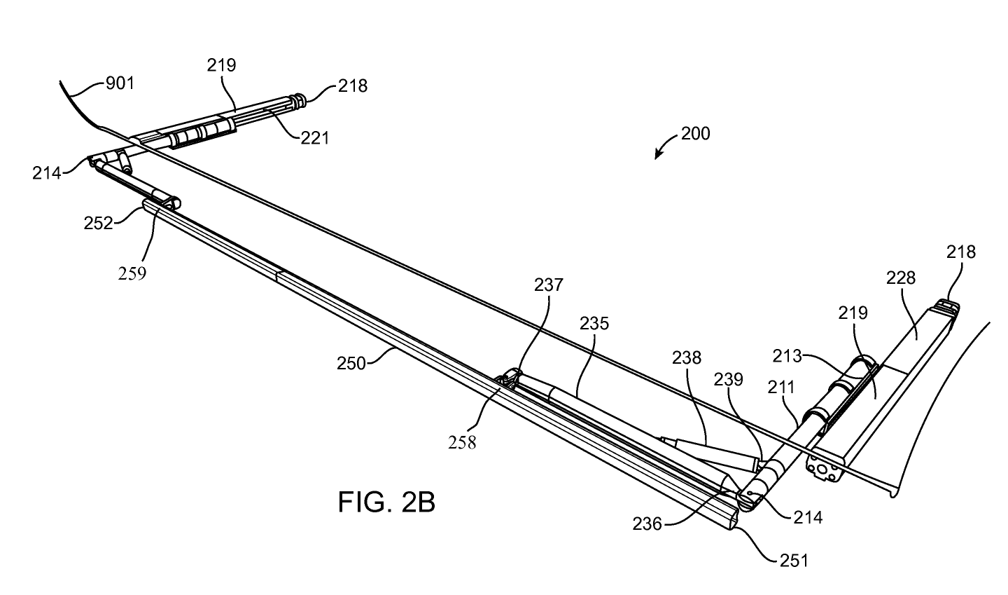

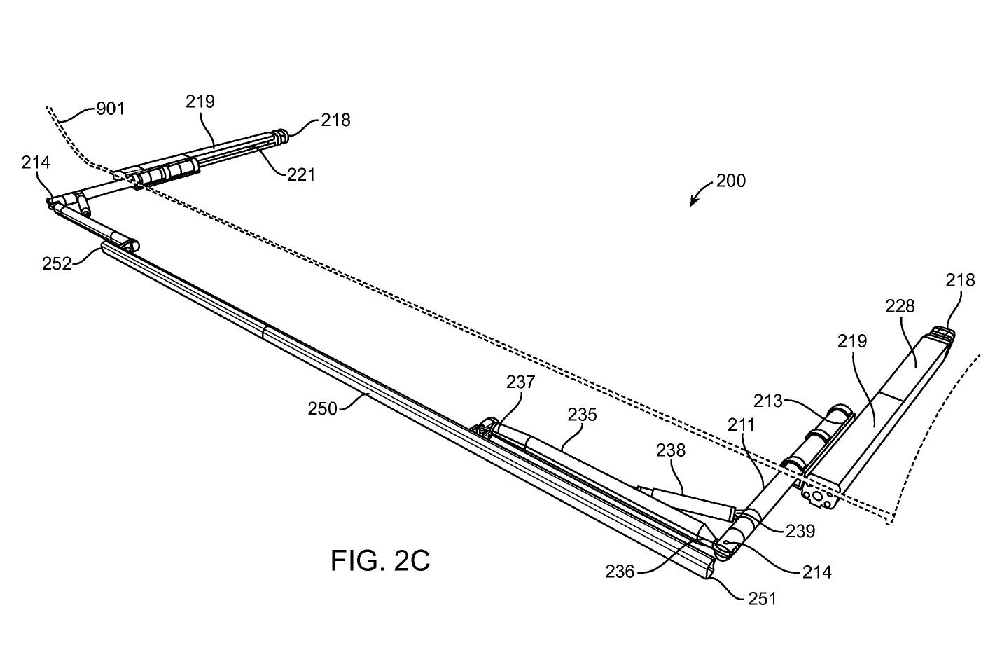

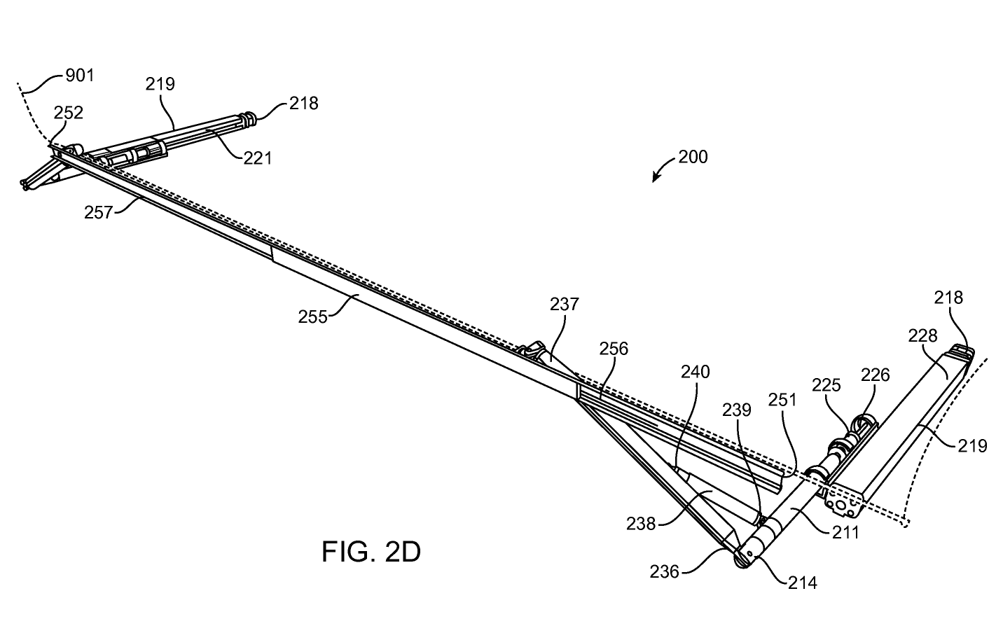

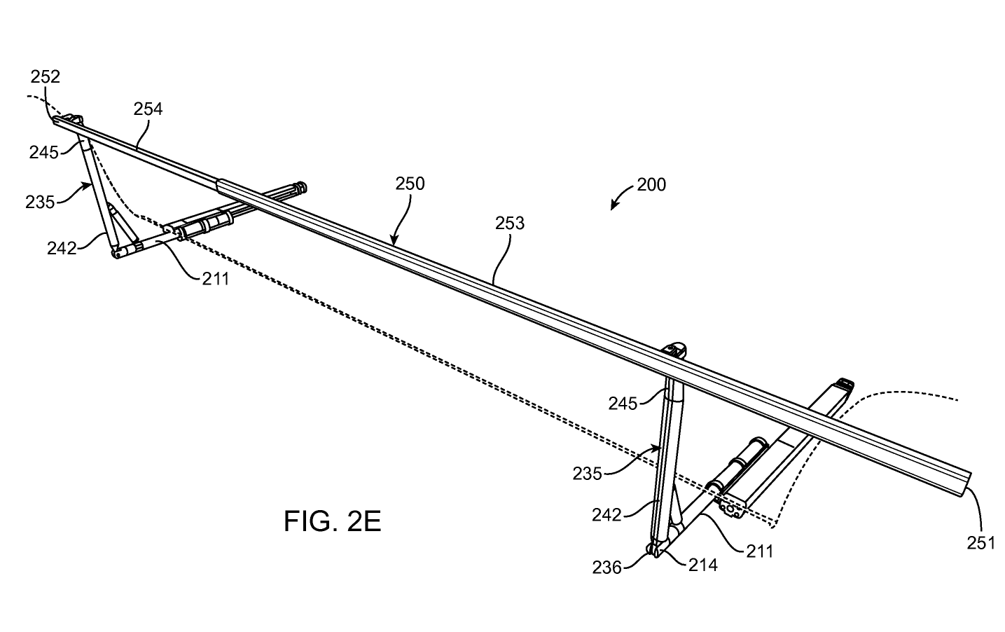

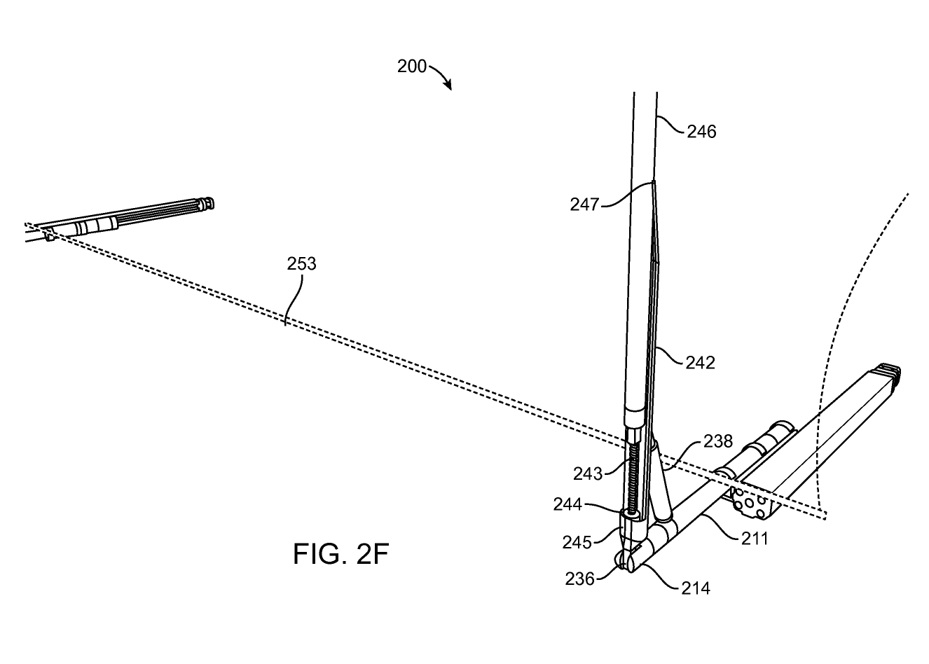

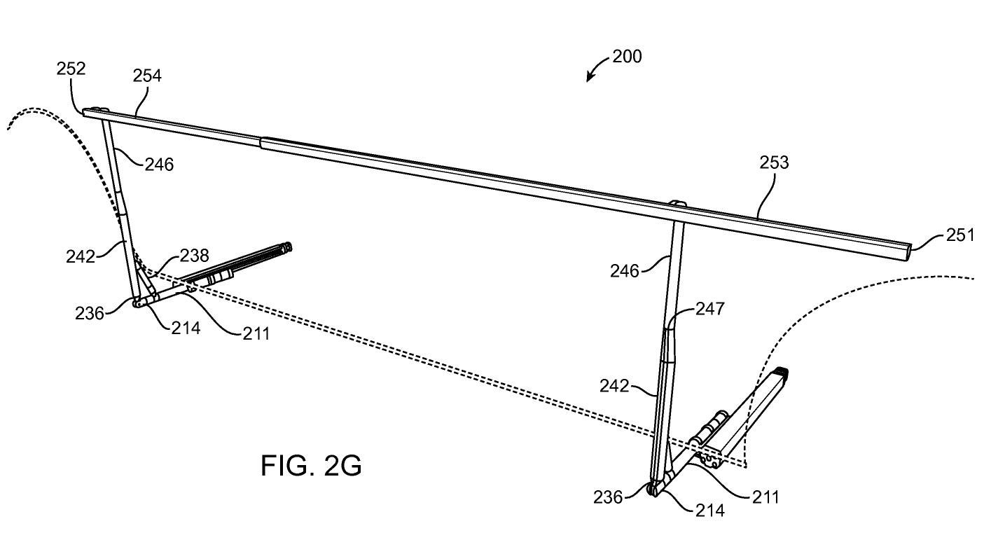

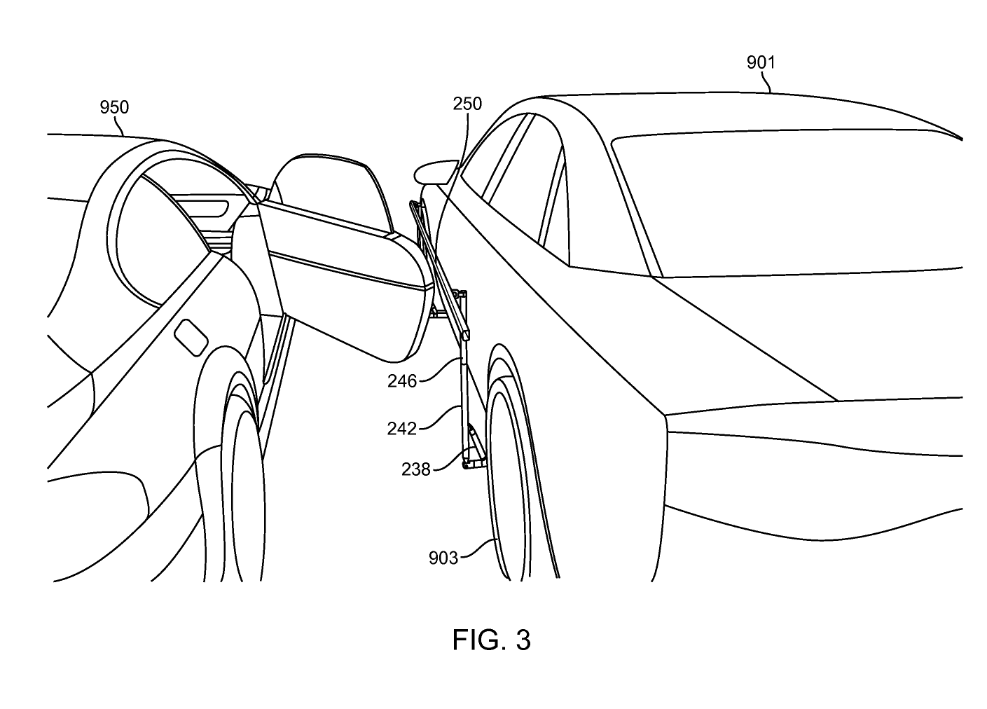

A FIG. 2 series of figures may depict exemplary embodiments of a side protector 200, in various stages of deployment and/or retraction. The FIG. 2 series of figures comprises FIG. 2A through FIG. 2G. Note, in the FIG. 2 series of figures, a front of subject vehicle 901 may be towards a left side of the FIG. 2 figures, while a rear of subject vehicle 901 may be towards a right side of the FIG. 2 figures. However, one of ordinary skill in the art should appreciate that this front to rear orientation depicted in the FIG. 2 figures could be reversed in other embodiments without deviating from the scope of the present invention.

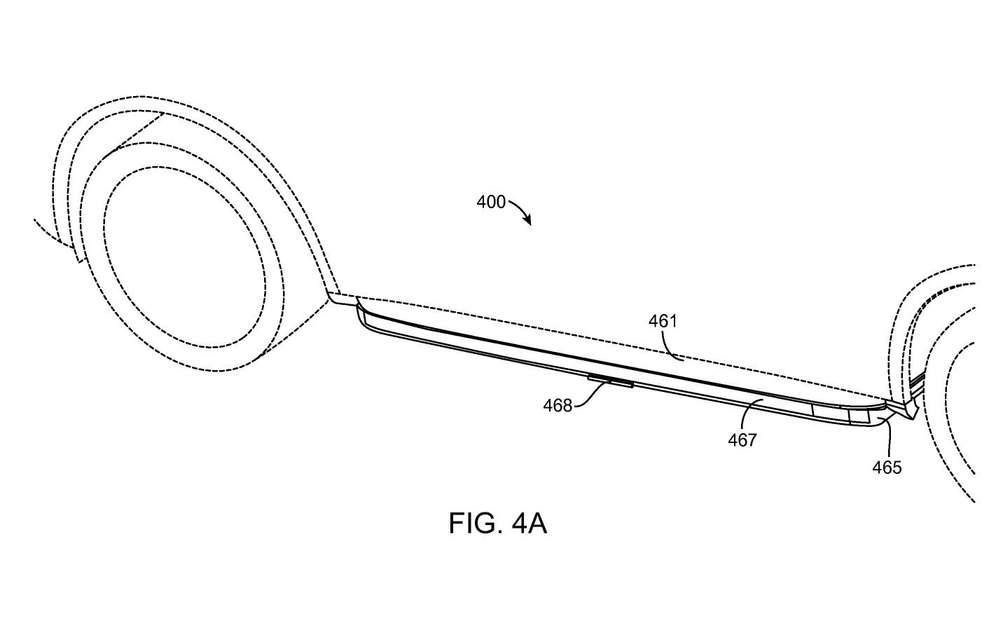

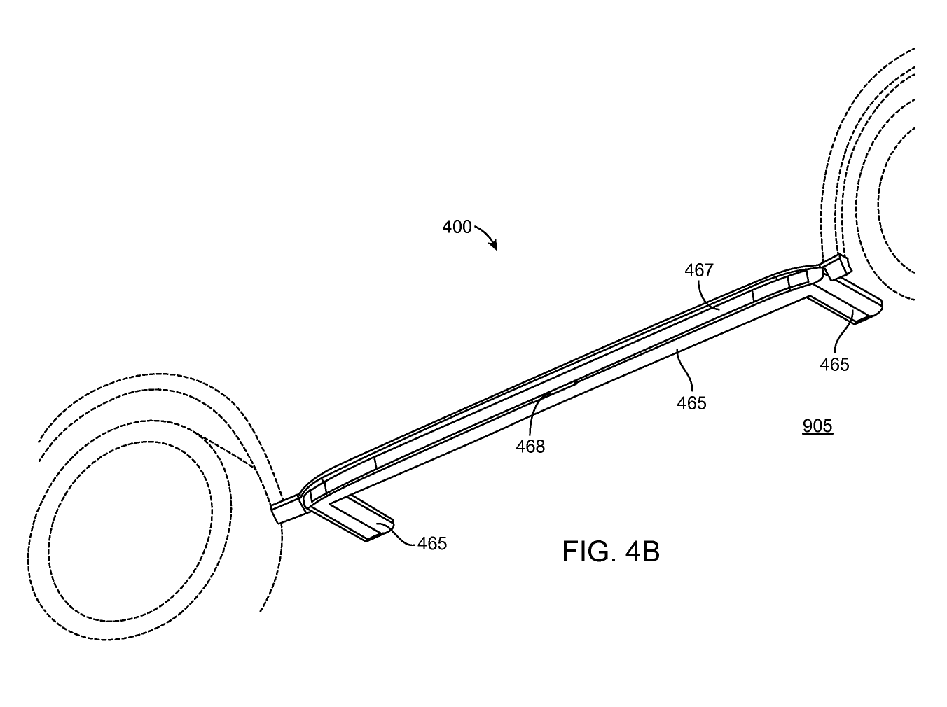

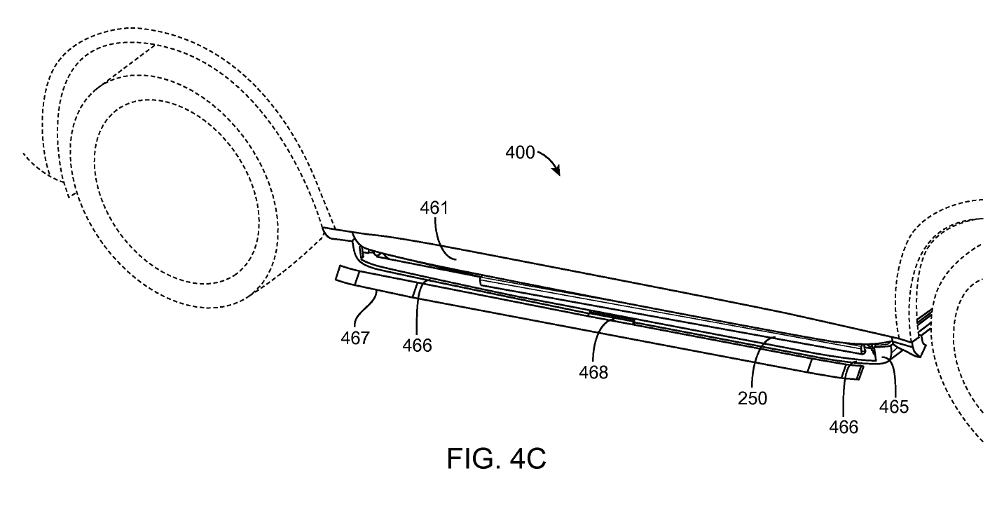

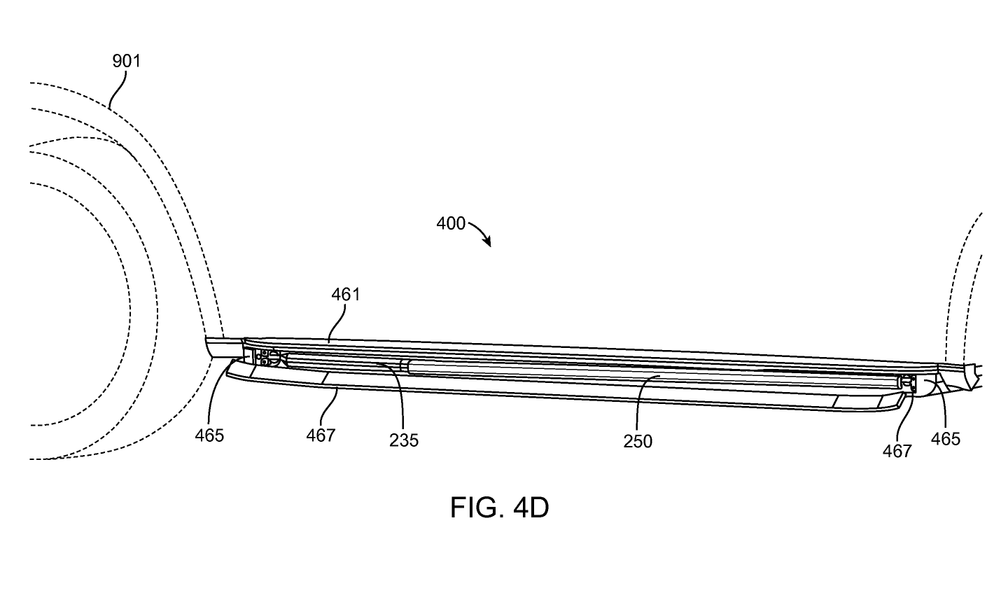

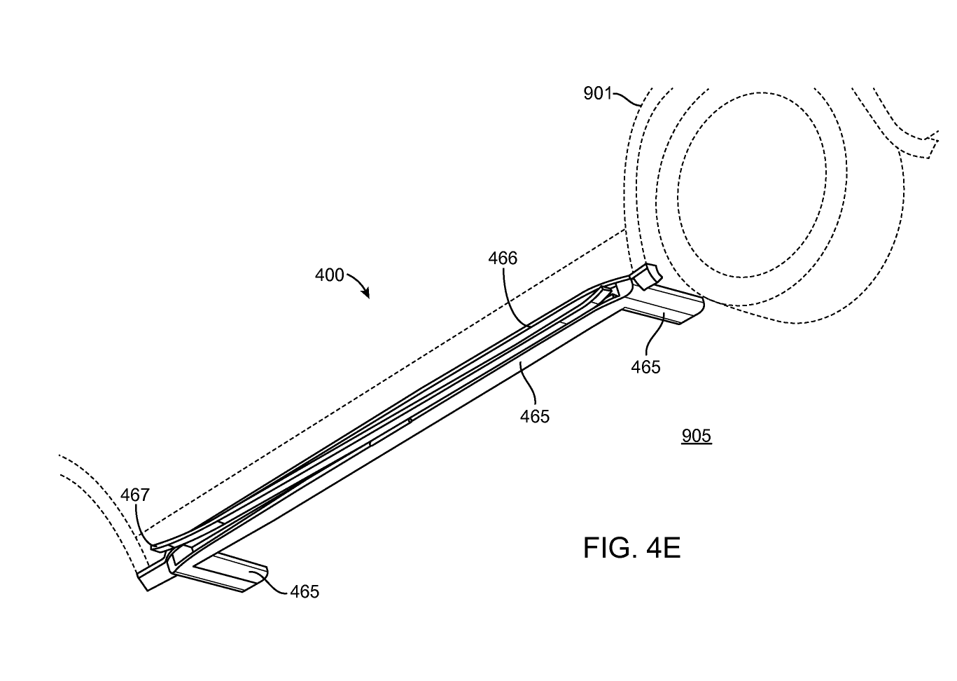

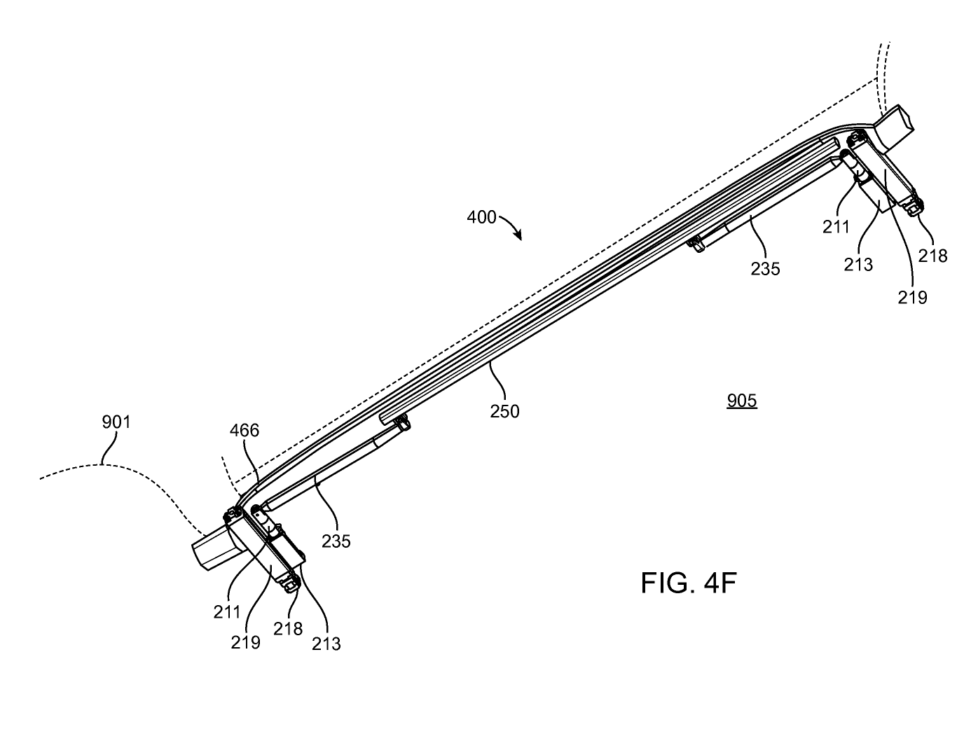

FIG. 2A, FIG. 2B, and FIG. 2C may depict a progression of horizontal deployment of extension arms 211. FIG. 2A may depict an exemplary embodiment of a deployable side protector 200, hereinafter side protector 200, for protecting subject vehicle 901 from side impacts—wherein in FIG. 2A the side protector 200 may be depicted in a fully retracted configuration—shown in a perspective view. This fully retracted configuration may be a storage configuration, i.e. a configuration in which subject vehicle 901 may be operated normally, e.g. driven without impedance by side protector 200. In some embodiments, in the fully retracted configuration, an entirety of side protector 200 may reside beneath undercarriage 905 (depicted in FIGS. 4B, 4E, and 4F) of subject vehicle 901. In some embodiments, in the fully retracted configuration, an entirety of side protector 200 may be directly integrated into a frame (a chassis) of subject vehicle 901. FIG. 2B may depict the exemplary embodiment of FIG. 2A, but where side protector 200 may be in a state of partial horizontal deployment (or partial state of retraction)—but not yet in a state of full operational deployment (or in a state of the fully retracted configuration). In FIG. 2B, extension arms 211 may be partially horizontally deployed (or partially horizontally retracted). Until full horizontal deployment of extension arms 211, there may be no rotational movement of extension arms 211 from a rotator 225 (see FIG. 2D for rotator 225). FIG. 2C may depict the exemplary embodiment of FIG. 2A, but where side protector 200 may be in a state of full horizontal deployment—but not yet in a state of full operational deployment. In FIG. 2C, extension arms 211 may be fully horizontally deployed. In some embodiments, once this stage of full horizontal deployment may be reached, extension arms 211 may then be rotated by a rotator 225 (see FIG. 2D for rotator 225) to erect each vertical-support-strut-subassembly 235 (VSSS 235) to a vertical configuration (see e.g., FIGS. 2E, 2F, and 2G for vertical configurations).

Continuing discussing FIG. 2A, FIG. 2B, and FIG. 2C, in some embodiments side protector 200 may comprise at least one mounted-extension-rotation-subassembly (MERS), at least one VSSS 235, and at least one horizontal-vehicle-side-protection-bar-subassembly 250 (HVSPBS 250). In some exemplary embodiments, each side (right and left) of subject vehicle 901 may each comprise one side protector 200. In some exemplary embodiments, each such side protector 200 may comprise: two MERS (one front and one rear), two VSSS 235 (one front and one rear), and at least one HVSPBS 250.

In some embodiments, at least one MERS may comprise: a mounting structure 228, an extension actuator, extension arm 211, and rotator 225. In some embodiments, each MERS of the FIG. 2 series may be functionally similar to MERS 110 and 120 of the FIG. 1 series of figures. In some embodiments, each MERS of the FIG. 2 series may be structurally similar to MERS 110 and 120 of the FIG. 1 series of figures.

In some embodiments, mounting structure 228 may be mounted to undercarriage 905 of the subject vehicle 901 between front wheel 902 and rear wheel 903 of the same side of the subject vehicle 901. In some embodiments, mounting structure 228 may be a metal plate, which may comprise at least one hole in some embodiments for receiving a screw and/or bolt. Such mounting may be typical for a metal on metal mounting (fastening) in the automotive industry, such as, but not limited to, welding, use of screws, bolts, and the like.

In some embodiments, the extension actuator may provide deployment away from subject vehicle 901 or retraction towards subject vehicle 901 of the extension arm 211 in a horizontal direction substantially parallel with a plane of undercarriage 905. That is, in some embodiments, such horizontal deployment or horizontal retraction of extension arm 211 may be in a direction orthogonal from subject vehicle 901.

In some embodiments, extension arm 211 may be a first elongate member. In some embodiments, this first elongate member may be a rigid member. In some embodiments, one portion of extension arm 211 may be fixedly mounted to the extension actuator such that when the extension actuator translates in the horizontal direction that extension arm 211 may also translate in the horizontal direction, within a predetermined range of translation, from fully horizontally deployed to fully retracted. In some embodiments, a portion of the extension actuator may be attached to mounting structure 228, which may be in turn mounted to undercarriage 905.

In some embodiments, at least one VSSS 235 may be a second elongate member. In some embodiments, at least one VSSS 235 may comprise a bottom terminal end 236 disposed opposite of a top terminal end 237 (see e.g., FIG. 2B). In some embodiments, bottom terminal end 236 may be pivotally attached to a disposed terminal end 214 of extension arm 211. In some embodiments, rotator 225 (see e.g., FIG. 2D for rotator 225) may be axially connected to extension arm 211 opposite of disposed terminal end 214, such that rotator 225 may cause extension arm 211 to rotate, which in turn may cause at least one VSSS 235 to transition from a horizontal configuration (e.g. a retracted and/or a stored configuration) substantially parallel to the plane of undercarriage 905 to the vertical configuration (e.g. an erect configuration of VSSS 235) with top terminal end 237 disposed away from a ground (e.g. a road surface or parking space surface) (see e.g., FIG. 2E).

Continuing discussing FIG. 2A, FIG. 2B, and FIG. 2C, in some embodiments at least one HVSPBS 250 may be pivotally attached to top terminal end 237 of at least one VSSS 235. In some embodiments, at least one HVSPBS 250 may be a third elongate member. In some embodiments, at least one VSSS 235 may provide structural linkage between at least one HVSPBS 250 and the at least one MERS. In some exemplary embodiments, two VSSS 235 may provide structural linkage between at least one HVSPBS 250 and the two MERS, see e.g., FIG. 2A, FIG. 2B, and FIG. 2C.

In some embodiments, at least one HVSPBS 250 may comprise at least one LED (light emitting diode), facing away from subject vehicle 901. In some embodiments, at least one HVSPBS 250 may comprise at least one reflector or reflective surface disposed outwards, facing away from subject vehicle 901.

In some embodiments, side protector 200 may exist in two operational configurations: the fully retracted configuration (see e.g., FIG. 2A) and a fully deployed protection configuration (see e.g., FIG. 2G). In the fully retracted configuration, extension arm 211 may be retracted below the undercarriage 905 in some embodiments, and at least one VSSS 235 may be in the horizontal configuration and also below the undercarriage 905 in some embodiments. Whereas, in the fully deployed protection configuration, extension arm 211 may be fully horizontally deployed with a portion of extension arm 211 extending beyond undercarriage 905 (see e.g., FIG. 2C), and at least one VSSS 235 may be in the vertical configuration, beyond the undercarriage 905, lifting at least one HVSPBS 250 into a height off of the ground that may permit at least one HVSPBS 250 to receive impacts and protect subject vehicle 901.

In some embodiments (e.g. the embodiments depicted in the FIG. 2 series of figures), each side protector 200 may comprise two MERS, two VSSS 235, and one HVSPBS 250. In exemplary embodiments, subject vehicle may have two such side protectors 200, one per vehicle side (right and left). In some embodiments, the two MERS may comprise a front MERS and a rear MERS. In some embodiments, mounting structure 228 of the front MERS may be located closer to the front wheel 902 than to the rear wheel 903 on the same side of subject vehicle 901. In some embodiments, mounting structure 228 of the rear MERS may be located closer to rear wheel 903 than to front wheel 902 on the same side of subject vehicle 901.

In some embodiments, the two VSSS 235 may comprise a front VSSS 235 and a rear VSSS 235. In some embodiments, each VSSS 235 (front VSSS 235 and a rear VSSS 235) may comprise substantially the same elements and structures. In some embodiments, bottom terminal end 236 of front VSSS 235 may be pivotally attached to disposed terminal end 214 of the front MERS. In some embodiments, bottom terminal end 236 of rear VSSS 235 may be pivotally attached to disposed terminal end 214 of the rear MERS (see e.g., FIG. 2B).

Continuing discussing FIG. 2A, FIG. 2B, and FIG. 2C, in some embodiments, the one HVSPBS 250 may comprise a front-terminal-end 252 disposed opposite of a rear-terminal-end 251. See e.g., FIG. 2A. In some embodiments, rear-terminal-end 251 or a location 258 on the one HVSPBS 250 within a proximate distance of rear-terminal-end 251 may be pivotally attached to top terminal end 237 of the rear VSSS 235. See e.g., FIG. 2B. For example, and without limiting the scope of the present invention, this proximate distance may vary from 48 inches to location 258 being at rear-terminal-end 251. In some embodiments, a point 259 at front-terminal-end 252 may be pivotally attached to top terminal end 237 of the front VSSS 235. See e.g., FIG. 2B. In some embodiments, point 259 may be within 37 inches of front-terminal-end 252, wherein point 259 may define where on HVSPBS 250 may be pivotally attached to the top terminal end 237 of the rear vertical-support-strut-subassembly (VSSS) 235.

In some embodiments, the extension actuators of the front MERS and the rear MERS may be synchronized such that (horizontal) extension motion may be synchronized and retraction motion may be synchronized. In some embodiments, rotators 225 of the front MERS and the rear MERS may be synchronized such that when rotator 225 of the front MERS rotates towards front wheel 902, that rotator 225 of the rear MERS may rotate towards rear wheel 903. That is, in some embodiments, rotational movement of each rotator 225 on the same side of subject vehicle 901 may be synchronized opposing rotational movement.

Continuing discussing FIG. 2A, FIG. 2B, and FIG. 2C, in some embodiments the extension actuator may comprise a worm drive. In some embodiments, the worm drive may comprise: a screw arm 216, a slide 217, an extension-motor 218, and an extension actuator housing 219. In some embodiments, screw arm 216 may be a threaded linear elongate member. In some embodiments, screw arm 216 may be mounted axially to a central axis of extension-motor 218 such that a longitude of the central axis and a longitude of screw arm 216 may be substantially parallel and substantially concentric. In some embodiments, slide 217 may comprise a central hole complimentary to the threaded linear elongate member that may receive screw arm 216. In some embodiments, when the central axis spins, the screw arm may also spin, which may cause slide 217 to translate along a longitude of screw arm 216. In some embodiments, slide 217 and screw arm 216 may be located within extension actuator housing 219.

In some embodiments with two MERS, i.e. the front MERS and the rear MERS, the longitude of each screw arm 216 on the same side of subject vehicle 901 may be substantially parallel with each other.

In some embodiments, extension actuator housing 219 may comprise a slot 221. See e.g., FIG. 2B. In some embodiments, slot 221 may run along a longitude of extension actuator housing 219, such that the one portion of the extension arm 211 that may be fixedly mounted to the extension actuator may be attached to slide 217 through slot 221. In some embodiments, the one portion of extension arm 211 may comprise at least one extension arm bracket 212 and/or a L-bracket 213 (see e.g., FIG. 2B, FIG. 2C, and FIG. 4F). A portion of L-bracket 213 may be attached through slot 221 to slide 217. See e.g., FIG. 2B for slot 221 and FIG. 2A for L-bracket 213 mounted to slide 217. The at least one extension arm bracket 212 may be a sleeve 212 (i.e. a collar 212, e.g. as a type of housing in some embodiments), such that rotational movement, but not linear translational movement, of extension arm 211 may be permitted with respect to the at least one extension arm bracket 212.

In some embodiments, an upper exterior (surface) of extension actuator housing 219 may be mounted to the mounting structure 228, and may then be mounted to undercarriage 905. In some embodiments, a portion of the upper exterior of extension actuator housing 219 may be mounting structure 228. See e.g., FIG. 2B.

FIG. 2D may depict the exemplary embodiment of FIG. 2A, but where side protector 200 may be in a state of partial rotational deployment (and in a state of full horizontal deployment)—but not yet in a state of full operational deployment. In FIG. 2D each VSSS 235 may be in a process of being erected into the vertical configuration (or rotated away from the vertical configuration).

In some embodiments, rotator 225 may comprise a motor 225. In some embodiments, motor 225 may comprise a central spinning axis 226. In some embodiments, central spinning axis 226 may be attached to extension arm 211 opposite of disposed terminal end 214, such that a longitude of central spinning axis 226 and a longitude of the extension arm 211 may be substantially parallel and concentric, such that when central spinning axis 226 may rotates by motor 225, extension arm 211 may also rotate.

Continuing discussing FIG. 2D, in some embodiments, at least one VSSS 235 may comprise an impact absorber 238. In some embodiments, impact absorber 238 may be a linear telescoping member comprising a lower end 239 disposed opposite of an upper end 240. In some embodiments, lower end 239 may be attached to the extension arm 211 within a proximate distance from the disposed terminal end 214. In some embodiments, such an attachment may be a pivot attachment. For example, and without limiting the scope of the present invention, this proximate distance may be 8 inches or less. In some embodiments, upper end 240 may be attached to a strut housing 242 of at least one VSSS 235. In some embodiments, such an attachment may be a pivot attachment. In some embodiments, impact absorber 238 may be a hydraulic or pneumatic shock absorber. In some embodiments, impact absorber 238 may be a spring, e.g. a coil spring.

Continuing discussing FIG. 2D, in some embodiments, the one HVSPBS 250 may comprise a slide 255. In some embodiments, slide 255 may be housed within third elongate member 257. In some embodiments, slide 255 and an interior of third elongate member 257 may comprise a complimentary tongue and groove structure for translational sliding of slide 255 within third elongate member 257 in a direction along a longitude of third elongate member 257. In some embodiments, top terminal end 237 of front VSSS 235 may be pivotally attached to a point on slide 255 through a bar-slot 256 of third elongate member 257. In some embodiments, bar-slot 256 may run substantially parallel with the longitude for less than a length of third elongate member 257 on a vehicle side of third elongate member 257 which may face subject vehicle 901.

In some embodiments, slide 255 may be a reinforcement core to each HVSPBS 250. In such embodiments, slide 255 may act to minimize bending and/or breakage of each HVSPBS 250 when fully deployed. In some embodiments, slide 255 may be rigid to semi-rigid. In some embodiments, slide 255 may be hardened yet flexible. In terms of materials and structure, slide 255 may be similar to a base region of a deep sea fishing pole (rod). For example, and without limiting the scope of the present invention, such materials may comprise carbon graphite and the like. In some embodiments, slide 255 may be substantially constructed of a thermoformed plastic, injection molded, extruded, and/or 3D printed. In some embodiments, when each HVSPBS 250 may be fully deployed, each slide 255 may be disposed between rear-terminal-end 251 and front-terminal-end 252, substantially occupying a middle portion of each HVSPBS 250.

In some embodiments, at least one tongue may be located on slide 255, with at least one groove (e.g. a rail or a guide) located within the interior of third elongate member 257. In some embodiments, at least one groove (e.g. the rail or the guide) may be located on slide 255 and the at least one tongue may be located on the interior of third elongate member 257. The tongue and the groove may be complimentary to each other for translational sliding movement along the longitude of third elongate member 257.

In some embodiments, rotational movement of the front MERS moving front top terminal end 237 towards front wheel 902 and synchronized rotational movement of the rear MERS of rear top terminal end 237 towards rear wheel 903 on the same side of subject vehicle 901, may cause sliding of slide 255 along the longitude of third elongate member 257 towards the front wheel and front-terminal-end 252 (i.e., in a deploying motion). In some embodiments, rotational movement of the front MERS of front terminal end 237 away front wheel 902 and synchronized rotational movement of the rear MERS of rear terminal end 237 away from rear wheel 903 on the same side of subject vehicle 901, may cause sliding of slide 255 along the longitude of third elongate member 257 towards rear-terminal-end 251 (i.e., in a retraction motion). Note, in FIG. 2E, front wheel 902 may be located on the left side of the figure, while rear wheel 903 may be located towards the right side of the figure, and note front wheel 902 and rear wheel 903 may not actually be depicted in FIG. 2E.

In some embodiments, slide 255 may be replaced with an equivalent “rear slide” wherein sliding towards rear-terminal-end 251 may be associated with deployment and sliding toward front-terminal-end 252 may be associated with retraction (storage).

In some embodiments, slide 255 may be a portion of front bar 254. In such embodiments, a portion (proximal to front-terminal-end 252) of front bar 254 may be substantially hollow, while a portion proximal to front bar 254's remaining terminal end (that may inserted into a hollow portion of rear bar 253) may comprise slide 255. In some such embodiments, slide 255 may be fixed with respect to front bar 254, i.e. no translational sliding between slide 255 and front bar 254. Further, in some such embodiments, there may be no slot 256. That is, in such embodiments, slide 255 may be reinforcement core 255. Front bar 254 may comprise reinforcement core 255 located at the portion of front bar 254 remaining within the hollow portion of rear bar 253 such that the reinforcement core is disposed between front-terminal-end 252 and the rear-terminal-end 251. Reinforcement core 255 may be selected from substantially rigid to semi-rigid providing structural reinforcement to third elongate member 257 (e.g. HVSPBS 250). See FIG. 2E for front bar 254 and see FIG. 2D for reinforcement core 255.

FIG. 2E may depict the exemplary embodiment of FIG. 2A, but where side protector 200 may be in a state of full rotational deployment (and full horizontal deployment). In some embodiments, which do not comprise an additional vertical extender, the depiction in FIG. 2E, may be the fully deployed protection configuration. Whereas, in some embodiments, which may comprise at least one vertical extender, the depiction in FIG. 2E may not yet be in a state of full operational deployment, i.e. not the fully deployed protection configuration. Vertical extender embodiments may be depicted in FIG. 2F and FIG. 2G.

In FIG. 2E, extension arms 211 may be fully horizontally extended (orthogonally away from subject vehicle 901's side). In FIG. 2E, each VSSS 235 may be in the vertical configuration by extension arms 211 being rotated into position by rotators 225 (see FIG. 2D for rotators 225).

In some embodiments, the third elongate member of at least one HVSPBS 250 may comprise two sub-members that may telescope with respect to each other. In some embodiments these two sub-members may comprise front bar 254 and rear bar 253. In some embodiments third elongate member 257 may comprise front bar 254 and rear bar 253. In some embodiments, front-terminal-end 252 may be located at one terminal end of front bar 254. In some embodiments, rear-terminal-end 251 may be located at one terminal end of rear bar 253. In some embodiments, the remaining two terminal ends of each sub-member (disposed in between front-terminal-end 252 and rear-terminal-end 251), i.e. one terminal end of front bar 254 and one terminal end of rear bar 253, may interact in a sliding and telescoping fashion such that a portion of front bar 254 may slidingly remain within a hollow portion of rear bar 253. In some embodiments, a length of that portion (that may slidingly interact) may vary such that this length may always be less than a total length of rear bar 253, but more than one centimeter (cm). Or in some embodiments, conversely and equivalently, a portion of rear bar 253 may slidingly remain within a hollow portion of front bar 254 (not depicted).

In some embodiments, rotational movement of the front MERS towards front wheel 902 and synchronized rotational movement of the rear MERS towards rear wheel 903 on the same side of subject vehicle 901, may cause telescoping extension of front bar 254 from rear bar 253—but not far enough rotation such that front bar 254 becomes disengaged from rear bar 253. In some embodiments, rotational movement of the front MERS away front wheel 902 and synchronized rotational movement of the rear MERS away from rear wheel 903 on the same side of subject vehicle 901, may cause telescoping compaction (retraction) of front bar 254 towards rear bar 253.

FIG. 2F may depict the exemplary embodiment of FIG. 2A, but where side protector 200 may be in a state of partial vertical deployment (and full rotational deployment and full horizontal deployment) by use of the vertical extender—but not yet in a state of full operational deployment. Strut housing 242 may be depicted in a cutaway view to show a vertical-screw-arm 243, portions of a vertical-motor 244, and portions of a strut 246—that may all be housed within strut housing 242.

In some embodiments, at least one VSSS 235 may comprise the vertical extender. In some embodiments, the vertical extender may comprise vertical-screw-arm 243, vertical-motor 244, strut housing 242, and strut 246. In some embodiments, strut housing 242 and strut 246 may form the second elongate member of at least one VSSS 235. In some embodiments, vertical-motor 244 may be housed within a base 245 of strut housing 242 located proximally to bottom terminal end 236. For example, and without limiting the scope of the present invention, proximally may be from one millimeter (mm) to five cm. In some embodiments, a shaft of vertical-motor 244 may be attached to vertical-screw-arm 243 in a substantially parallel and concentric manner. In some embodiments, vertical-screw-arm 243 may be a threaded linear elongate member. In some embodiments, strut 246 may be a linear elongate member. In some embodiments, this linear elongate member of strut 246 may be rigid. In some embodiments, this linear elongate member of strut 246 may comprise a complimentary central hole sized to receive the vertical-screw-arm 243, such that when the shaft spins, vertical-screw-arm 243 may rotate, which in turn may cause strut 246 to translate in a vertical direction along a longitude of the vertical-screw-arm 243 either upwards extending or downwards retracting depending upon a direction of spin. In some embodiments, the complimentary central hole may run along an entire longitudinal length of strut 246, in an interior of strut 246, i.e. a spirally threaded interior of strut 246. In some embodiments, strut housing 242 may be a component of the second elongate member that may be substantially hollow, sized to house vertical-screw-arm 243, and sized to receive a portion of strut 246. In some embodiments, top terminal end 237 may be located at one end of the strut 246, not housed within strut housing 242. In some embodiments, bottom terminal end 236 may be located at one end of the strut housing 242.

FIG. 2G may depict the exemplary embodiment of FIG. 2A, but where side protector 200 may be in a state of full vertical deployment (and full rotational deployment and full horizontal deployment). FIG. 2G may depict a state of full operational deployment for side protector 200, i.e. the fully deployed protection configuration. In the fully deployed protection configuration, HVSPBS 250 may receive various impacts and blows, and HVSPBS's 250 presence disposed between the side of subject vehicle 901 and a source of the impact and/or blow may protect subject vehicle 901 from the impact and/or blow. In some embodiments, some of energy associated with the impact and/or blow may be absorbed by impact absorber(s) 238.

FIG. 3 may depict the state of full operational deployment, the fully deployed protection configuration, for side protector 200, while the side protector 200 may be operating to protect subject vehicle 901 from a side impact originating from an adjacent vehicle 950, shown from a perspective view. A vehicle door of adjacent vehicle 950 may be seen in FIG. 3 striking HVSPBS 250 (which may also be HVSPBS 150 in some embodiments), and protecting subject vehicle 901 from the striking FIG. 3 may depict an exemplary example application of the configuration depicted in FIG. 2G, while in use with at least one adjacent vehicle 950.

A FIG. 4 series of figures may depict embodiments of a modified running board 400 that may removably house elements of side protector 200 (or side protector 100, in some embodiments). Running boards may be common on sports utility vehicles (SUVs) and pickup trucks. The FIG. 4 series of figures may comprise FIG. 4A through FIG. 4F. In some embodiments, when side protector 200 (or side protector 100, in some embodiments) may be in the fully retracted configuration the elements may be housed (stored) within a side-protector-housing 465 of running board 400.

FIG. 4A may depict an exemplary embodiment of side protector 200 (or 100) incorporated into subject vehicle's 901 running board 400, shown from a top perspective view with a side-protector-housing door 467, also known as a running board door 467 in some embodiments, (or door 467 hereinafter) closed.

FIG. 4B may depict the exemplary embodiment of FIG. 4A, but from a bottom perspective view also showing door 467 closed and showing side-protector-housing 465 which may house (store) elements of side protector 200 (or 100).

FIG. 4C may depict the exemplary embodiment of FIG. 4A, also from the top perspective view but showing door 467 open.

FIG. 4D may depict the exemplary embodiment of FIG. 4A, from a side perspective view showing door 467 open.

FIG. 4E may depict the exemplary embodiment of FIG. 4A, but from the bottom perspective view showing door 467 open and showing side-protector-housing 465 which may house (store) elements of side protector 200 (or 100).

FIG. 4F may depict the exemplary embodiment of FIG. 4A, but from the bottom perspective view showing door 467 open and showing a bottom portion of side-protector-housing 465 removed (cutaway) so side protector 200 (or 100) may be seen in the retracted and stored configuration, i.e. in the fully retracted configuration.

As depicted in the FIG. 4 series of figures, various embodiments of the invention may comprise running board 400. In some embodiments, running board 400 may be mounted to the side of subject vehicle 901. In some embodiments, running board 400 may be mounted to an undercarriage of subject vehicle 901 and partially protrude to a side of subject vehicle 901. In some embodiments, running board 400 may comprise a top platform 461 and below and integral to top platform 461 side-protector-housing 465. In some embodiments, top platform 461 may removably receive footsteps of users of subject vehicle 901 (e.g. when such users may be getting in or out of subject vehicle 901 or cleaning subject vehicle 901 or interacting with top exterior portions of subject vehicle 901, and the like). In some embodiments, side-protector-housing 465 may removably house two VSSS 235 and one HVSPBS 250. See e.g., FIG. 4F. In some embodiments, side-protector-housing 465 may houses the two MERS (front and rear) such that each extension arm 211 may be substantially extendable beyond side-protector-housing 465. A portion of each extension arm 211 may remain in side-protector-housing 465, e.g., the portion which attaches to slide 217. In some embodiments, when side protector 200 (or 100) may be in the fully retracted configuration, side-protector-housing 465 may cover bottoms and sides of two VSSS 235, one HVSPBS 250, and the two MERS. In some embodiments, two VSSS 235, one HVSPBS 250, and portions of the two extension arms 211 may deploy or retract through a side-protector-housing opening 466 (see e.g., FIG. 4C) facing away from subject vehicle 901 and opening substantially perpendicular to the top platform 461. In some embodiments, running board 400 may further comprise door 467 sized to removably close side-protector-housing opening 466. In some embodiments, door 467 may be attached to side-protector-housing 465 by a hinge 468, e.g. at or proximal (within 5 cm) to some portion of side-protector-housing opening 466, such as a bottom central portion of side-protector-housing opening 466. See e.g., FIG. 4C. In some embodiments, hinge 468 may be a spring hinge which keeps door 467 closed except when door 467 is pushed open and/or forced open by elements of side protector 200 (or 100).

In some embodiments, running board 400 may comprise side protector 200 (or 100). In some embodiments, mounting structure 228 may be mounted to undercarriage 905 of subject vehicle 901 between the front wheel 902 and the rear wheel 903 of the same side of the subject vehicle 901. And side-protector-housing 466 may then be installed over the fully retracted configuration. Or in some embodiments, mounting structure 228 may be mounted to an upper interior surface of the side-protector-housing 466, in which case may substantially covers all sides, tops, and bottom of side protector 200 (or 100) while in the fully retracted configuration with door 467 closed.

In some embodiments, side protector 200 (or 100) of running board 400 may exist in two operational configurations: the fully retracted configuration and the fully deployed protection configuration. In the fully retracted configuration, extension arm 211 may be retracted below top platform 461 and below a portion of undercarriage 905 and at least one VSSS 235 in the horizontal configuration below top platform 461 and a portion of undercarriage 905. In the fully deployed protection configuration, extension arm 211 may be fully horizontally deployed with a portion extending beyond undercarriage 905 and beyond side-protector-housing opening 466, such that at least one VSSS 235 may be in the vertical configuration, lifting at least one HVSPBS 250 into the height off of the ground that permits at least one HVSPBS 250 to receive side impacts and protect subject vehicle 901.

In some embodiments, side protector 200 (or 100) may not comprise impact absorber 238 (or 136 and 146). See e.g., FIG. 4F. In such embodiments, top platform 461 may act as an impact absorber. Or in such embodiments, housing 465 may act as an impact absorber. Or in such embodiments, mounting structure 228 may act as an impact absorber. Or in such embodiments, undercarriage 905 that is connected to mounting structure 228 may act as an impact absorber.

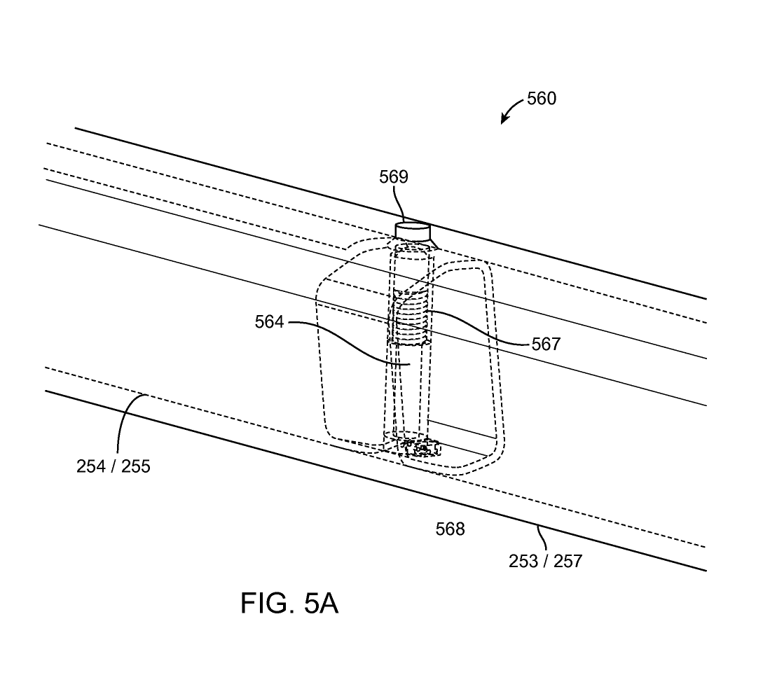

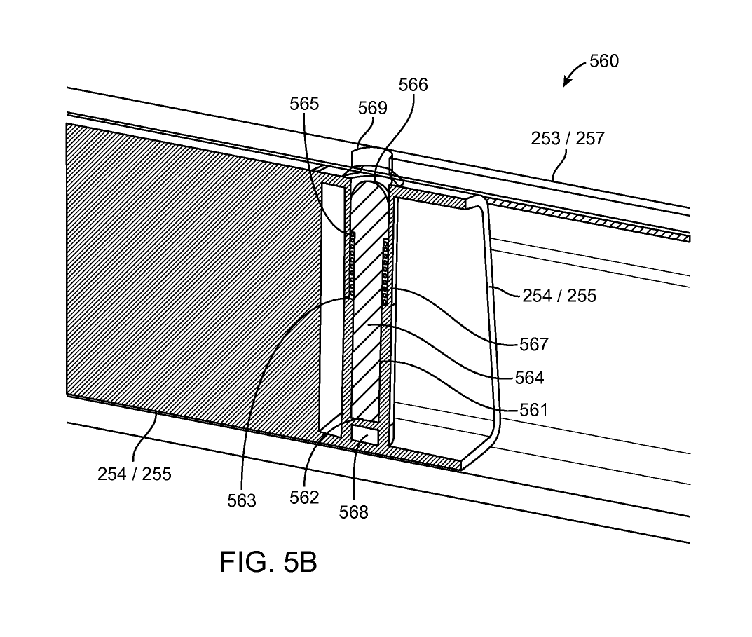

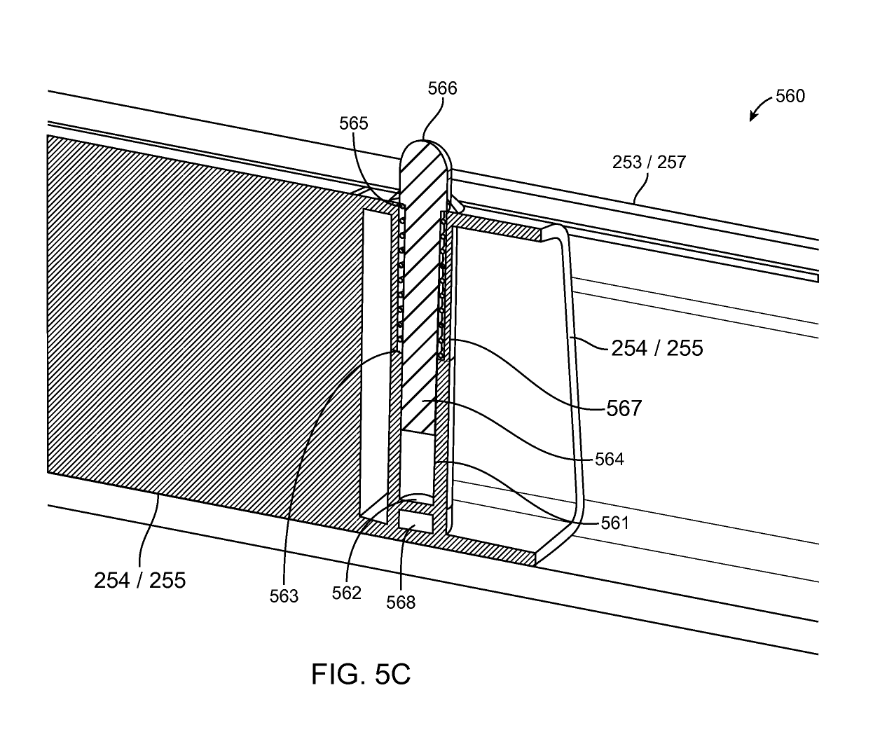

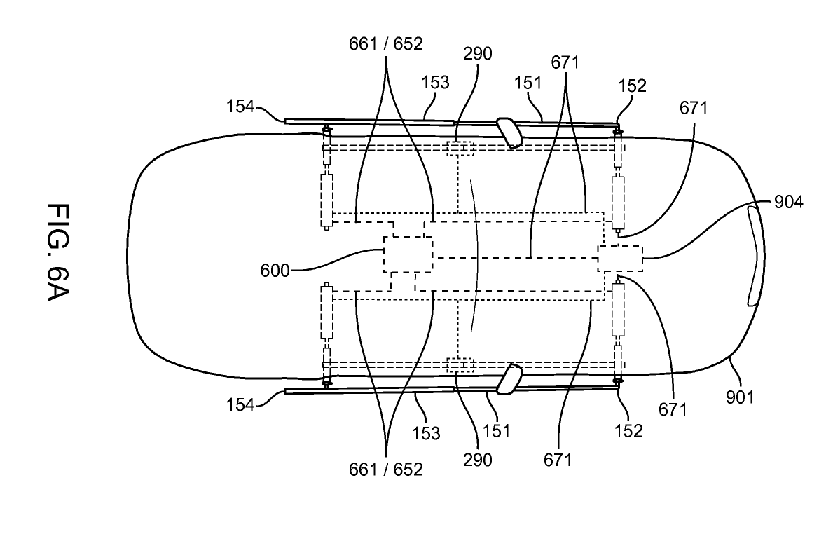

A FIG. 5 series of figures may depict embodiments of a securing pin subassembly 560 for locking of sliding and/or telescoping embodiments of HVSPBS 250. The FIG. 5 series of figures may comprise FIG. 5A through FIG. 5C.

FIG. 5A may depict an exemplary embodiment of securing pin subassembly 560, with a securing pin 564 (pin 564) in a retracted configuration, shown from a perspective transparent view. FIG. 5B may depict the exemplary embodiment of FIG. 5A, shown from a cross-sectional perspective view. In some embodiments, when pin 564 may be retracted, elements of HVSPBS 250 may be slidable and/or telescopable. FIG. 5C may depict the exemplary embodiment of FIG. 5A, but with pin 564 in a deployed (i.e. locked or secured) configuration, shown from the cross-sectional perspective view.

In some embodiments, HVSPBS 250 may comprise securing pin subassembly 560. In some embodiments, securing pin subassembly 560 may comprise a pin-cavity 561, pin 564, a spring 567, and an electro-magnet 568 located in front bar 254 or in slide 255 in other embodiments. In some embodiments, securing pin subassembly 560 also may comprise a complimentary-concentric-pin-hole 569 located in rear bar 253 or in the third elongate member 257 in other embodiments. In some embodiments, spring 567 may helically wrap around an outside diameter of some of pin 564. In some embodiments, a length of spring 567 may be disposed between a flange 565 of pin 564 and a different flange 563 of pin-cavity 561, such that spring 567 may be captured between flange 565 and different flange 563. See e.g., FIG. 5B and FIG. 5C. In some embodiments, spring 567 and substantially all of pin 564 may be housed within pin-cavity 561. In some embodiments, electro-magnet 568 may be located at a bottom 562 of pin-cavity 561. In some embodiments, when electro-magnet 568 may be activated pin 564 may be housed entirely within pin-cavity 561 by a magnetic field emitted from electro-magnet 568 that may compress spring 567 by pulling flange 565 towards bottom 562 and which then may permit translational sliding motion between the rear bar 253 and the front bar 254 or between slide 255 and third elongate member 257 in other embodiments. In some embodiments, pin 564 may comprise sufficient ferrous metals to be attracted in the magnetic field emitted by electro-magnet 568. In some embodiments, when electro-magnet 566 may not be activated (not energized), spring 565 may push a top portion 566 of pin 564 out of complimentary-concentric-pin-hole 569 when complimentary-concentric-pin-hole 569 may be concentric with a top opening of pin-cavity 561. In some embodiments, the top opening of pint-cavity 561 may be disposed opposite of bottom 562. In some embodiments, such removable protrusion of top portion 566 may secure a deployed configuration of the rear bar 253 to the front bar 254; or may secure a deployed configuration of slide 255 to third elongate member 257 other embodiments.

In some embodiments, retraction from the deployed configuration to the stored and/or the retracted configuration of front bar 254 and rear bar 253 (or of slide 255 and third elongate member 257 in other embodiments), may occur by first energizing electro-magnet 568, which may then permit the translational sliding motion because the magnetic field may pulls pin 564 towards bottom 562 and out of complimentary-concentric-pin-hole 569. In some embodiments, retraction from the deployed configuration to the stored and/or retracted configuration, may occur by a user manually depressing top portion 566, such that top portion 566 may longer protrude from complimentary-concentric-pin-hole 569, which may then permit the translational sliding motion.

FIG. 6A and FIG. 6B may depict retraction locking magnet 290. In some embodiments, retraction locking magnet 290 may be used to secure HVSPBS 250 to undercarriage 905 when subject vehicle may be in motion, e.g. by being driven. In some embodiments, retraction locking magnet 290 may serve to protect HVSPBS 250 from coming loose during driving. In some embodiments, retraction locking magnet 290 may serve to minimize noise from side protector 200 rattling during driving of subject vehicle 901. In some embodiments, retraction locking magnet 290 may serve to protect side protector 200 from road debris, dangerous road conditions, and the like.

In some embodiments, side protector 200 may comprise retraction locking magnet 290. In some embodiments, retraction locking magnet 290 may be mounted to undercarriage 905, such that when side protector 200 may be in the fully retracted configuration a portion of at least one HVSPBS 250 may be within a magnetic field emitted by retraction locking magnet 290 that may removably secure at least one HVSPBS 250 to undercarriage 905. In some embodiments, retraction locking magnet 290 may be an electro magnet. In some embodiments, retraction locking magnet 290 may be in communication with power source 904. The portion of at least one HVSPBS 250 may comprise sufficient ferrous metals to be attracted in the magnetic field emitted by retraction locking magnet 290.

Now turning to controller 600 as depicted in FIG. 6A, FIG. 6B, and FIG. 6C. FIG. 6C may depict exemplary embodiment of controller 600 for controlling the deployment and retraction of side protector 100, shown as a schematic block diagram. In some embodiments, controller 600 may comprise: receiver 601, memory 602, processor 603, output means 604, and incoming power 671.

In some embodiments, receiver 601 may be configured to receive various inputs direct at controller 600 and may include the ability to receive hard-wired inputs and/or wireless inputs from various wireless communication protocols. In some embodiments, receiver 601 may receive inputs from a stand-alone remote control, generally via a wireless communication protocol. Note, the stand-alone remote may be a smart phone, tablet computing device and the like, or any other handheld computing device with a communication ability. In some embodiments, receiver 601 may receive input from subject vehicle 901, for example, as directed by the user interacting with subject vehicle 901's console (e.g., dashboard). Further, receiver 601 may receive various feedback and/or status signals from the various MERS. And receiver 601 may receive firmware or other software updates for non-transitory storage onto memory 602.

In some embodiments, memory 602 may be configured to non-transitorily store firmware and/or other software that may provide processing instructions to processor 603 of how to handle and deal with the various inputs received by receiver 601.

Processor 603 may interpret the various inputs received by receiver 601 according to the firmware and/or software non-transitorily stored within memory 602. Then according to such interpretations, processor 603 may send various signals to output means 604. In various exemplary embodiments, memory 602 and processor 603 may be replaced with an integrated circuit for handling a limited set of intended inputs to receiver 601.

Output means 604 may then send outgoing signals to various intended recipients. For example, and without limiting the scope of the present invention, outgoing signals may be sent to power source 904, instructing power source 904 to provide power to each pair of front and rear MERS 110 and 120 (or to each pair of front and rear MERS of side protector 200), where such power may then be used to either deploy or retract. Power source 904 may originate from subject vehicle 901 (e.g. from a battery and/or an operating alternator). Additionally output signals may be sent to the MERS requesting each MERS to send back a signal containing configuration status information directed at receiver 601.

Incoming power source 671 may be configured (e.g. by transformers and/or conditioners in line before controller 600) to allow electricity of the proper characteristics (e.g. polarity, voltage, AC or DC, and the like) to flow into controller 600, so that controller 600 may operate. The electrical power flowing to incoming power source 671 may originate with or from subject vehicle 901.

In further exemplary embodiments, controller 600 may further comprise transmitter 605. Transmitter 605 may be configured to transmit appropriate wireless signals intended for the stand-alone remote control, conveying status information, such as what configuration side protector 100 (or side protector 200 or running board 400) may be in, whether any error signals have been received by receiver 601, and/or whether HVSPBS 150 or 250 may have received a side impact blow detected by one or more sensors in communication with HVSPBS 150 or 250.

In some embodiments, side protector 200 (or side protector 100 or running board 400) may comprise controller 600 for controlling deployment and retraction of elements of side protector 200 (or side protector 100 or running board 400). In some embodiments, these elements may comprise at least one VSSS 235, at least one HVSPBS 250, and portions of extension arms 211 which may removably extend beyond the undercarriage 905. In some embodiments, controller 600 may be a standalone controller or in other embodiments, controller 600 may be an integral computer of subject vehicle 901, factory installed by a manufacturer of subject vehicle 901. In some embodiments, a standalone controller 600 may be mounted on or within subject vehicle 901, such as, but not limited to, attached to undercarriage 905 or within proximity (e.g. within four feet) of subject vehicle's 901 existing computer or within subject vehicle's 901 dashboard. In some embodiments, controller 600 may comprise, receiver 601, memory 602, processor 603, and output means 604.

In some embodiments, receiver 601 may receive at least one input directed at controller 600 arising from at least one electronic component of side protector 200 (or side protector 100 or running board 400). In some embodiments, at least one electronic component may be selected from one or more of the group comprising: a remote control, a vehicle console input device, the extension actuator, the rotator 225, a vertical extender, electro-magnet 568, a retraction locking magnet 290, power source 904, one or more power switches, one or more sensors, and the like.

In some embodiments, the at least one input may be input 651 and/or input 652. See e.g., FIG. 6C. In some embodiments, input 651 may originate from the remote control and/or the vehicle console input device. In some embodiments, input 651 may be a wireless communication, such as, but not limited to, a radio frequency. In some embodiments, input 651 may comprise a command, such that the upon receipt of said command by receiver 601, the software instructing processor 603 may recognize said command and respond accordingly. In some embodiments, the command may be a deployment command, a retraction command, and/or a command requesting status feedback information.

In some embodiments, the one or more sensors may be optical sensors, motion sensors, pressure sensors, and the like. In some embodiments, the one or more sensors may be in communication with one or more of the extension actuator, rotator 225, the vertical extender, electro-magnet 568, retraction locking magnet 290, power source 904, and the one or more power switches. In some embodiments, the one or more power switches may be in communication with one or more of the extension actuator, rotator 225, the vertical extender, electro-magnet 568, retraction locking magnet 290, power source 904, and the one or more sensors. In some embodiments, the vehicle console input device may be located (and integral in some embodiments) within and accessible from subject vehicle's 901 dashboard.

In some embodiments, memory 602 may non-transitorily store software. In some embodiments, the software may comprise instructions to processor 603 of how to respond to the at least one input received by the receiver 601. In some embodiments, the software may be firmware. In some embodiments, updates to the software may be inputted into memory 602 by receiving software updates via receiver 601. In some embodiments, controller 600 may comprise a port, e.g. a USB (universal serial bus) port, for receiving software updates.

In some embodiments, processor 603 may interpret the at least one input received by receiver 601 according to the software non-transitorily stored within the memory 602 to generate at least one output signal 661 via output means 604 by processor 603 directing a signal to output means 604. In some embodiments, processor 603 may be in communication (e.g. wired communication and/or printed circuit board communication) with at least three of receiver 601, memory 602, output means 604, the port, a transmitter 605, and the like.

In some embodiments, output means 604 may be a relay. In some embodiments, output means 604 may send (e.g. transmit via a wired or wired communication) at least one output signal 661 to the at least one electronic component.

In some embodiments, at least one output signal 661 may cause either deployment from the fully retracted configuration to the fully deployed protection configuration; or may cause retraction from the fully deployed protection configuration to the fully retracted configuration. In some embodiments, at least one output signal 661 may be directed to the one or more power switches. In some embodiments, upon receipt of at least one output signal 661 the one or more power switches may causes electrical power from power source 904 to reach one or more of the extension actuator, rotator 225, the vertical extender, electro-magnet 568, and/or retraction locking magnet 290. In some embodiments, each of the extension actuator, rotator 225, the vertical extender, electro-magnet 568, and retraction locking magnet 290 may be in communication with its own power switch.

In some embodiments, controller 600 may be in communication with at least three of the group consisting of from a given side protector 200: the extension actuator, rotator 225, the vertical extender, electro-magnet 568, retraction locking magnet 290, the one or more power switches, the one or more sensors, and power source 904.

In some embodiments, controller 600 may comprise transmitter 605. In some embodiments, transmitter 605 may transmit outgoing communication messages 681 regarding a status of side protector 200. In some embodiments, the status may be deployment or retraction configuration status, an error status, an impact notification, and the like. In some embodiments, the status may be determined in accordance with the software interpreting the at least one input. In some embodiments, transmitter 605 may be in communication with processor 603. In some embodiments outgoing message 681 transmitted by transmitter 605 may be received by the remote control, such as the smartphone, the tablet computing device, and the like.

In some embodiments, transmitter 605 may comprise a visual indicator and/or an audible indicator. In some embodiments, the visual indicator may be one or more of at least one LED (light emitting diode), or a display screen. In some embodiments, the audible indicator may comprise a speaker, a buzzer, and/or a whistle. In some embodiments, the visual indicator and/or the audible indicator may emit warning messages and/or notifications, such as when side protector 200 may be in motion and/or when side protector 200 may receive an impact.

In some embodiments, the invention may comprise a method for deployment or retraction of side protector 200 (or 100). In some embodiments, the method may comprise the steps of: (a) a receiving step, (b) an interpreting step, (c) a sending step, and (d) another different receiving step.

In some embodiments, step (a) the receiving step may comprise receiving a deployment input signal or a retraction input signal from the remote control, the vehicle console input device, or a sensor (e.g. at least one of the one or more sensors). In some embodiments, the deployment input signal or the retraction input signal may be received at receiver 601 of controller 600.

In some embodiments, step (b) the interpreting step may comprise interpreting the deployment input signal or the retraction input signal to generate the at least one output signal 661 for deployment or for retraction. In some embodiments, processor 603 may do the interpreting according to the software (non-transitorily stored within memory 602).

In some embodiments, step (c) the sending step may comprise sending at least one output signal 661 to the one or more power switches. In some embodiments, output means 604 may send at least one output signal 661 (according to a signal received by output means 604 from processor 603).

In some embodiments, step (d) the different receiving step may comprise receiving at least one output signal 661 by the one or more power switches. In some embodiments, receipt of at least one output signal 661 may cause either deployment from the fully retracted configuration to the fully deployed protection configuration; or may cause retraction from the fully deployed protection configuration to the fully retracted configuration. In some embodiments, upon receipt of at least one output signal 661, the one or more power switches may cause electrical power from power source 904 to reach one or more of the extension actuator, rotator 225, the vertical extender, electro-magnet 568, and/or retraction locking magnet 290—but not necessarily in that order. In some embodiments, each of the extension actuator, rotator 225, the vertical extender, electro-magnet 568, and/or retraction locking magnet 290 may be in communication with its own power switch. In some embodiments, the one or more power switches, controller 600, the extension actuator, the rotator 225, the vertical extender, electro-magnet 568, and/or retraction locking magnet 290 may all be electrical components of the side protector 200.

In some embodiments, the method may further comprise step (e)(1) or step (e)(2); where step (e)(1) and step (e)(2) may be mutually exclusive with respect to each other. In some embodiments, step (e)(1) may comprise deployment steps. In some embodiments, step (e)(2) may comprise retraction steps. In some embodiments, step (e)(2) may be a reverse of step (e)(1). In some embodiments, whether step (e)(1) or step (e)(2) follow step (d) may depend upon a current configuration status of side protector 200. For example, and without limiting the scope of the present invention, if side protector 200 may be in the fully retracted configuration, then step (e)(1) may follow step (d). In some embodiments, whether step (e)(1) or step (e)(2) follow step (d) may depend upon a current configuration status of side protector 200. For example, and without limiting the scope of the present invention, if side protector 200 may be in the fully deployed protection configuration, then step (e)(2) may follow step (d).

In some embodiments, whether step (e)(1) or step (e)(2) follow step (d) may depend upon information (e.g. a type of command) contained within input 651 received by receiver 601 and how the software may be preconfigured to interpret said information (e.g. the command).

In some embodiments, step (e)(1) may comprise deployment steps for deploying from the fully retracted configuration to the fully deployed protection configuration. In some embodiments, the deployment steps may comprise: activating power to the extension actuator; and once the extension actuator may have finished horizontal deployment; activating power to rotator 225; and then in embodiments which may include the vertical extender, activating power to the vertical extender.

In some embodiments, upon activating power to the extension actuator, upon receipt of at least one output signal 661 at a power switch in communication with the extension actuator, this power switch may then permit electrical power from power source 904 to power the extension actuator to extend extension arm 211.

In some embodiments, activating power to rotator 225, upon receipt of at least one output signal 661 at a power switch in communication with rotator 225, this power switch may then permit electrical power from power source 904 to power rotator 225 to rotate top terminal end 237 of at least one VSSS 235 towards a wheel of the subject vehicle 901 that may be closest.

In some embodiments, activating power to the vertical extender, upon receipt of at least one output signal 661 at a power switch in communication with vertical-motor 244, this power switch may then permit electrical power from power source 904 to power vertical-motor 244 to strut 246 of each VSSS 235 to raise HVSPBS 250 into place at the height off of the ground.

In some embodiments, step (e)(2) may comprise retraction steps for retracting from the fully deployed protection configuration to the fully retracted configuration. In some embodiments, the deployment steps may comprise: in embodiments which may include the vertical extender, activating power to the vertical extender; then once the vertical extender may have finished retracting, if the vertical extender was included in the embodiment, activating power to rotator 225; and once each VSSS 235 may be in the horizontal configuration, activating power to the extension actuator.

In some embodiments, activating power to the vertical extender, upon receipt of at least one output signal 661 at a power switch in communication with vertical-motor 244, this power switch may then permit electrical power from power source 904 to power vertical-motor 244 to strut 246 of each VSSS 235 to lower HVSPBS 250 from the height off of the ground.

In some embodiments, activating power to rotator 225, upon receipt of at least one output signal 661 at a power switch in communication with rotator 225, this power switch may then permit electrical power from power source 904 to power rotator 225 to rotate top terminal end 237 of at least one VSSS 235 away from the wheel of the subject vehicle 901 that may be closest.

In some embodiments, upon activating power to the extension actuator, upon receipt of at least one output signal 661 at a power switch in communication with the extension actuator, this power switch may then permit electrical power from power source 904 to power the extension actuator to fully retract extension arm 211.

In some embodiments, whether the extension actuator, rotator 225, and/or the vertical extender translate or rotate in a particular direction may depend upon a polarity of at least one output signal 661.

Note, use of “substantially” in the above may denote that absolute qualities need not be met. For example, and without limiting the scope of the present invention, “substantially parallel” or “substantially perpendicular” may denote that the geometric quality need not be met absolutely, but the spirit of that quality may be important. Use of “substantially” in the above may denote that absolute qualities may vary by 5 percent from the absolute quality. Note, use of “about” with respect to a dimension may mean plus or minus 10 percent variance with respect to the dimensions stated.

A deployable side protector (side protector) for protecting a subject vehicle from side impacts has been described and disclosed. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A side protector for protecting a subject vehicle from side impacts, wherein the side protector comprises:
at least one mounted-extension-rotation-subassembly; wherein the at least one mounted-extension-rotation-subassembly comprises: a mounting structure, an extension actuator, an extension arm, and a rotator; wherein the mounting structure is mounted to an undercarriage of the subject vehicle between a front wheel and a rear wheel of a same side of the subject vehicle; wherein the extension actuator provides deployment away from the subject vehicle or retraction towards the subject vehicle of the extension arm in a horizontal direction substantially parallel with a plane of the undercarriage; wherein the extension arm is a first elongate member; wherein one portion of the extension arm is mounted to the extension actuator such that the extension arm translates in the horizontal direction; wherein a portion of the extension actuator is attached to the mounting structure;
at least one vertical-support-strut-subassembly; wherein the at least one vertical-support-strut-subassembly is a second elongate member; wherein the at least one vertical-support-strut-subassembly comprises a bottom terminal end disposed opposite of a top terminal end; wherein the bottom terminal end is pivotally attached to a disposed terminal end of the extension arm; wherein the rotator is axially connected to the extension arm opposite of the disposed terminal end, such that the rotator causes the extension arm to rotate, which in turn causes the at least one vertical-support-strut-subassembly to transition from a horizontal configuration substantially parallel to the plane to a vertical configuration with the top terminal end disposed away from a ground; and
at least one horizontal-vehicle-side-protection-bar-subassembly pivotally attached to the top terminal end of the at least one vertical-support-strut-subassembly; wherein the at least one horizontal-vehicle-side-protection-bar-subassembly is a third elongate member;
wherein the at least one vertical-support-strut-subassembly provides structural linkage between the at least one horizontal-vehicle-side-protection-bar-subassembly and the at least one mounted-extension-rotation-subassembly;
wherein the side protector exists in two operational configurations: a fully retracted configuration with the extension arm retracted and the at least one vertical-support-strut-subassembly in the horizontal configuration, and a fully deployed protection configuration with the extension arm fully horizontally deployed, the at least one vertical-support-strut-subassembly is in the vertical configuration, lifting the at least one horizontal-vehicle-side-protection-bar-subassembly into a height off of the ground that permits the at least one horizontal-vehicle-side-protection-bar-subassembly to receive side impacts and protect the subject vehicle.

2. The side protector according to claim 1, wherein each side protector comprises two mounted-extension-rotation-subassemblies, two vertical-support-strut-subassemblies, and one horizontal-vehicle-side-protection-bar-subassembly; wherein the two mounted-extension-rotation-subassemblies comprise a front mounted-extension-rotation-subassembly and a rear mounted-extension-rotation-subassembly, wherein the mounting structure of the front mounted-extension-rotation-subassembly is located closer to the front wheel than to the rear wheel, wherein the mounting structure of the rear mounted-extension-rotation-subassembly is located closer to the rear wheel than to the front wheel; wherein the two vertical-support-strut-subassemblies comprises a front vertical-support-strut-subassembly and a rear vertical-support-strut-subassembly; wherein the bottom terminal end of the front vertical-support-strut-subassembly is pivotally attached to the disposed terminal end of the front mounted-extension-rotation-subassembly; wherein bottom terminal end of the rear vertical-support-strut-subassembly is pivotally attached to the disposed terminal end of rear mounted-extension-rotation-subassembly; wherein the one horizontal-vehicle-side-protection-bar-subassembly comprises a front-terminal-end disposed opposite of a rear-terminal-end; wherein the rear-terminal-end or a location on the one horizontal-vehicle-side-protection-bar-subassembly within a proximate distance of the rear-terminal-end is pivotally attached to the top terminal end of the front vertical-support-strut-subassembly; and wherein a point at the front-terminal-end or within 37 inches of the front-terminal-end is pivotally attached to the top terminal end of the rear vertical-support-strut-subassembly.

3. The side protector according to claim 2, wherein the extension actuators of the front mounted-extension-rotation-subassembly and the rear mounted-extension-rotation-subassembly are synchronized; and wherein the rotators of the front mounted-extension-rotation-subassemblies and the rear mounted-extension-rotation-subassemblies are synchronized such that when the rotator of the front mounted-extension-rotation-subassembly rotates towards the front wheel, the rotator of the rear mounted-extension-rotation-subassembly rotates towards the rear wheel.

4. The side protector according to claim 2, wherein the third elongate member comprises two sub-members that telescope with respect to each other, wherein the two sub-members are a front bar and a rear bar; wherein the front-terminal-end is located at one terminal end of front bar and the rear-terminal-end is located at one terminal end of the rear bar; wherein the remaining two terminal ends of each sub-member interact in a sliding and telescoping fashion such a portion of the front bar remains within a hollow portion of the rear bar wherein a length of the portion varies such that this length is always less than a total length of the rear bar and more than one centimeter.

5. The side protector according to claim 4, wherein the front bar comprises a reinforcement core located at the portion of the front bar remaining within the hollow portion of the rear bar such that the reinforcement core is disposed between the front-terminal-end and the rear-terminal-end; wherein the reinforcement core is selected from substantially rigid to semi-rigid providing structural reinforcement to the third elongate member.

6. The side protector according to claim 2, wherein the one horizontal-vehicle-side-protection-bar-subassembly comprises a securing pin subassembly; wherein the securing pin subassembly comprises a pin-cavity, a pin, a spring, and an electro-magnet located in the front bar; and wherein the securing pin subassembly also comprises a complimentary-concentric-pin-hole located in the rear bar; wherein the spring wraps around an outside diameter of some of the pin; wherein a length of the spring is disposed between a flange of the pin and a different flange of the pin-cavity; wherein the spring is housed within the pin-cavity and substantially all of the pin is housed within the pin-cavity; wherein the electro-magnet is located at a bottom of the pin-cavity; wherein when the electro-magnet is activated the pin is housed entirely within the pin-cavity by a magnetic field emitted from the electro-magnet that compresses the spring and permits translational sliding motion between the rear bar and the front bar; wherein when the electro-magnet is not activated, the spring pushes a top portion of the pin out of the complimentary-concentric-pin-hole when the complimentary-concentric-pin-hole is concentric with a top opening of the pin-cavity; wherein such removable protrusion of the top portion secures a deployed configuration of the rear bar to the front bar.

7. The side protector according to claim 2, wherein the side protector further comprises a running board mounted to the undercarriage of the subject vehicle, wherein the running board comprises a top platform and below and integral to the top platform a side-protector-housing which removably houses the two vertical-support-strut-subassemblies and the one horizontal-vehicle-side-protection-bar-subassembly; and wherein the side-protector-housing houses the two mounted-extension-rotation-subassemblies such that each extension arm is substantially extendable beyond the side-protector-housing; wherein in the fully retracted configuration, the side-protector-housing covers bottoms and sides of the two vertical-support-strut-subassemblies, the one horizontal-vehicle-side-protection-bar-subassembly, and the two mounted-extension-rotation-subassemblies; wherein the top platform removably receives footsteps of users of the subject vehicle; wherein the two vertical-support-strut-subassemblies, the one horizontal-vehicle-side-protection-bar-subassembly, and portions of the two extension arms deploy or retract through a side-protector-housing opening facing away from the subject vehicle and opening substantially perpendicular to the top platform; wherein the running board further comprises a door sized to removably close the side-protector-housing opening, attached to the side-protector-housing by a hinge.

8. The side protector according to claim 1, wherein the extension actuator comprises a worm drive, wherein the worm drive comprises: a screw arm, a slide, an extension-motor, and an extension actuator housing; wherein the screw arm is a threaded linear elongate member; wherein the screw arm is mounted axially to a central axis of the extension-motor; wherein the slide comprises a central hole complimentary to the threaded linear elongate member that receives the screw arm; such that when the central axis spins, the screw arm also spins, which causes the slide to translate along the screw arm; wherein the slide and the screw arm are located within the extension actuator housing.

9. The side protector according to claim 8, wherein the extension actuator housing comprises a slot, wherein the slot runs along a longitude of the extension actuator housing, such that the one portion of the extension arm is attached to the slide through the slot.

10. The side protector according to claim 8, wherein an upper exterior of the extension actuator housing is mounted to the mounting structure.

11. The side protector according to claim 1, wherein the rotator comprises a motor, wherein the motor comprises a central spinning axis, wherein the central spinning axis is attached to the extension arm opposite of the disposed terminal end, such that a longitude of the central spinning axis and a longitude of the extension arm are substantially parallel and concentric.

12. The side protector according to claim 1, wherein the at least one vertical-support-strut-subassembly comprises an impact absorber, wherein the impact absorber is a linear telescoping member comprising a lower end disposed opposite of an upper end; wherein the lower end is attached to the extension arm within a proximate distance from the disposed terminal end; and wherein upper end is attached to a strut housing of the at least one vertical-support-strut-subassembly.

13. The side protector according to claim 1, wherein the at least one vertical-support-strut-subassembly comprises a vertical extender, wherein the vertical extender comprises: a vertical-screw-arm, a vertical-motor, a strut housing, and a strut; wherein the strut housing and the strut form the second elongate member; wherein the vertical-motor is housed within a base of the strut housing located proximally to the bottom terminal end; wherein a shaft of the vertical-motor is attached to the vertical-screw-arm; wherein the vertical-screw-arm is a threaded linear elongate member; wherein the strut is a linear elongate member comprising a complimentary central hole sized to receive the vertical-screw-arm, such that when the shaft spins, the vertical-screw-arm rotates causing the strut to translate in a vertical direction along a longitude of the vertical-screw-arm; wherein the strut housing is a component of the second elongate member that is substantially hollow, sized to house the vertical-screw-arm, and sized to receive a portion of the strut; wherein the top terminal end is located at one end of the strut; wherein the bottom terminal end is located at one end of the strut housing.

14. The side protector according to claim 1, wherein the side protector comprises a retraction locking magnet; wherein the retraction locking magnet is mounted to the undercarriage, such that when the side protector is in the fully retracted configuration a portion of the at least one horizontal-vehicle-side-protection-bar-subassembly is within a magnetic field emitted by the retraction locking magnet that removably secures the at least one horizontal-vehicle-side-protection-bar-subassembly to the undercarriage.

15. The side protector according to claim 1, wherein the side protector further comprises a controller for controlling deployment and retraction of elements of the side protector; wherein the controller comprises:
a receiver for receiving at least one input directed at the controller arising from at least one electronic component of the side protector, wherein the at least one electronic component is selected from one or more of the group consisting of: a remote control, a vehicle console input device, the extension actuator, the rotator, a vertical extender, an electro-magnet, a retraction locking magnet, a power source, one or more power switches, and one or more sensors;
a memory for non-transitory storage of software; wherein the software comprises instructions to a processor of how to respond to the at least one input received by the receiver;
the processor for interpreting the at least one input received by the receiver according to the software non-transitorily stored within the memory to generate at least one output signal via an output means by the processor directing a signal to the output means; wherein the processor is in communication with the receiver, the memory, and the output means; and
the output means, wherein the output means sends the at least one output signal to the at least one electronic component;
wherein the at least one output signal causes either deployment from the fully retracted configuration to the fully deployed protection configuration or causes retraction from the fully deployed protection configuration to the fully retracted configuration; wherein the at least one output signal is directed to the one or more power switches; wherein upon receipt of the at least one output signal the one or more power switches causes electrical power from the power source to reach one or more of the extension actuator, the rotator, the vertical extender, the electro-magnet, and the retraction locking magnet; wherein each of the extension actuator, the rotator, the vertical extender, the electro-magnet, and the retraction locking magnet is in communication with its own power switch;
wherein the elements comprise at least one vertical-support-strut-subassembly, at least one horizontal-vehicle-side-protection-bar-subassembly, and portions of the extension arm which removably extend beyond the undercarriage;
wherein the controller is in communication with at least three of the group consisting of: the extension actuator, the rotator, the vertical extender, the electro-magnet, the retraction locking magnet, the one or more power switches, the one or more sensors, and the power source.

16. The protector according to claim 15, wherein the controller further comprises a transmitter for transmitting outgoing communication messages regarding a status of the side protector; wherein the transmitter is in communication with the processor; wherein the status is determined in accordance with the software interpreting the at least one input.

17. A running board that removably houses elements of a side protector, the running board comprising:
a top platform for removably receiving feet of users on an upper surface of the top platform, wherein the top platform is mounted to a side of a subject vehicle below subject vehicle doors of the subject vehicle on the side of the subject vehicle between a front wheel and a rear wheel of the same side of the subject vehicle such that the upper surface is substantially parallel with a plane of an undercarriage of the subject vehicle;
a side protector, wherein the side protector comprises:
at least one mounted-extension-rotation-subassembly; wherein the at least one mounted-extension-rotation-subassembly comprises: a mounting structure, an extension actuator, an extension arm, and a rotator; wherein the mounting structure is mounted to the undercarriage of the subject vehicle between the front wheel and the rear wheel of the same side of the subject vehicle; wherein the extension actuator provides deployment away from the subject vehicle or retraction towards the subject vehicle of the extension arm in a horizontal direction substantially parallel with the plane of the undercarriage; wherein the extension arm is a first elongate member; wherein one portion of the extension arm is mounted to the extension actuator such that the extension arm translates in the horizontal direction; wherein a portion of the extension actuator is attached to the mounting structure;
at least one vertical-support-strut-subassembly; wherein the at least one vertical-support-strut-subassembly is a second elongate member; wherein the at least one vertical-support-strut-subassembly comprises a bottom terminal end disposed opposite of a top terminal end; wherein the bottom terminal end is pivotally attached to a disposed terminal end of the extension arm; wherein the rotator is axially connected to the extension arm such that the rotator causes the extension arm to rotate, which in turn causes the at least one vertical-support-strut-subassembly to transition from a horizontal configuration substantially parallel to the plane to a vertical configuration with the top terminal end disposed away from a ground; and
at least one horizontal-vehicle-side-protection-bar-subassembly pivotally attached to the top terminal end of the at least one vertical-support-strut-subassembly; wherein the at least one horizontal-vehicle-side-protection-bar-subassembly is a third elongate member; wherein the at least one vertical-support-strut-subassembly provides structural linkage between the at least one horizontal-vehicle-side-protection-bar-subassembly and the at least one mounted-extension-rotation-subassembly;
wherein the side protector exists in two operational configurations: a fully retracted configuration with the extension arm retracted and the at least one vertical-support-strut-subassembly in the horizontal configuration, and a fully deployed protection configuration with the extension arm fully horizontally deployed, the at least one vertical-support-strut-subassembly is in the vertical configuration, lifting the at least one horizontal-vehicle-side-protection-bar-subassembly into a height off of the ground that permits the at least one horizontal-vehicle-side-protection-bar-subassembly to receive side impacts and protect the subject vehicle; and
a side-protector-housing which removably houses the at least one vertical-support-strut-subassembly and the at least one horizontal-vehicle-side-protection-bar-subassembly; and wherein the side-protector-housing houses the at least one mounted-extension-rotation-subassembly such that each extension arm is substantially extendable beyond the side-protector-housing; wherein in the fully retracted configuration, the side-protector-housing substantially covers bottoms and sides of the side protector; wherein the at least one vertical-support-strut-subassembly, the at least one horizontal-vehicle-side-protection-bar-subassembly, and portions of each extension arm deploy or retract through a side-protector-housing opening facing away from the subject vehicle and opening substantially perpendicular to the top platform; wherein the running board further comprises a door sized to removably close the side-protector-housing opening, attached to the side-protector-housing by a hinge.

18. A method for deployment or retraction of a side protector comprising the steps of:
receiving a deployment input signal or a retraction input signal from a remote control, a vehicle console input device, or a sensor, wherein the deployment input signal or the retraction input signal is received at a receiver of a controller; wherein the controller further comprises:
a memory for non-transitory storage of software; wherein the software comprises instructions to a processor of how to respond to the deployment input signal or the retraction input signal received by the receiver;
the processor for interpreting the deployment input signal or the retraction input signal received by the receiver according to the software non-transitorily stored within the memory to generate at least one output signal via an output means by the processor directing a signal to the output means; wherein the processor is in communication with the receiver, the memory, and the output means; and
the output means, wherein the output means sends the at least one output signal to one or more power switches;
interpreting the deployment input signal or the retraction input signal to generate the at least one output signal for deployment or for retraction; wherein the processor does the interpreting according to the software;
sending at least one output signal to one or more power switches; wherein the output means sends the at least one output signal;
receiving the at least one output signal by the one or more power switches; wherein receipt of the at least one output signal causes either deployment from a fully retracted configuration to a fully deployed protection configuration or causes retraction from the fully deployed protection configuration to the fully retracted configuration; wherein upon receipt of the at least one output signal, the one or more power switches causes electrical power from a power source to reach one or more of an extension actuator, a rotator, a vertical extender, an electro-magnet, and a retraction locking magnet; wherein each of the extension actuator, the rotator, the vertical extender, the electro-magnet, and the retraction locking magnet is in communication with its own power switch; and wherein the one or more power switches, the controller, the extension actuator, the rotator, the vertical extender, the electro-magnet, and the retraction locking magnet are all electrical components of the side protector; wherein the side protector comprises:
at least one mounted-extension-rotation-subassembly; wherein the at least one mounted-extension-rotation-subassembly comprises: a mounting structure, the extension actuator, an extension arm, and the rotator; wherein the mounting structure is mounted to an undercarriage of the subject vehicle between a front wheel and a rear wheel of a same side of the subject vehicle; wherein the extension actuator provides deployment away from the subject vehicle or retraction towards the subject vehicle of the extension arm in a horizontal direction substantially parallel with a plane of the undercarriage; wherein the extension arm is a first elongate member; wherein one portion of the extension arm is mounted to the extension actuator such that the extension arm translates in the horizontal direction; wherein a portion of the extension actuator is attached to the mounting structure;
at least one vertical-support-strut-subassembly; wherein the at least one vertical-support-strut-subassembly is a second elongate member; wherein the at least one vertical-support-strut-subassembly comprises a bottom terminal end disposed opposite of a top terminal end; wherein the bottom terminal end is pivotally attached to a disposed terminal end of the extension arm; wherein the rotator is axially connected to the extension arm such that the rotator causes the extension arm to rotate, which in turn causes the at least one vertical-support-strut-subassembly to transition from a horizontal configuration substantially parallel to the plane to a vertical configuration with the top terminal end disposed away from a ground; and
at least one horizontal-vehicle-side-protection-bar-subassembly pivotally attached to the top terminal end of the at least one vertical-support-strut-subassembly; wherein the at least one horizontal-vehicle-side-protection-bar-subassembly is a third elongate member; wherein the at least one vertical-support-strut-subassembly provides structural linkage between the at least one horizontal-vehicle-side-protection-bar-subassembly and the at least one mounted-extension-rotation-subassembly;
wherein the side protector exists in two operational configurations: the fully retracted configuration with the extension arm retracted and the at least one vertical-support-strut-subassembly in the horizontal configuration, and the fully deployed protection configuration with the extension arm fully horizontally deployed, the at least one vertical-support-strut-subassembly is in the vertical configuration, lifting the at least one horizontal-vehicle-side-protection-bar-subassembly into a height off of the ground that permits the at least one horizontal-vehicle-side-protection-bar-subassembly to receive side impacts and protect the subject vehicle.

19. The method according to claim 18, wherein the method comprises deployment steps for deploying from the fully retracted configuration to the fully deployed protection configuration; wherein the deployment steps comprise:
activating power to the extension actuator; wherein upon receipt of the at least one output signal at a power switch in communication with the extension actuator, this power switch permits electrical power from the power source to power the extension actuator to extend the extension arm; and
activating power to the rotator; wherein upon receipt of the at least one output signal at a power switch in communication with the rotator, this power switch permits electrical power from the power source to power the rotator to rotate the top terminal end of at least one vertical-support-strut-subassembly towards a wheel of the subject vehicle that is closest.

20. The method according to claim 18, wherein the method comprises retraction steps for retracting from the fully deployed protection configuration to the fully retracted configuration; wherein the retraction steps comprise:
activating power to the rotator; wherein upon receipt of the at least one output signal at a power switch in communication with the rotator, this power switch permits electrical power from the power source to power the rotator to rotate the top terminal end of at least one vertical-support-strut-subassembly away from a wheel of the subject vehicle that is closest; and
activating power to the extension actuator; wherein upon receipt of the at least one output signal at a power switch in communication with the extension actuator, this power switch permits electrical power from the power source to power the extension actuator to retract the extension arm.
